(19) United States
(12) Patent Application Publication
(10) Pub. No.: US 2010/0296606 A1
(43) Pub. Date: Nov. 25, 2010

(54) DIVERSITY RECEIVING APPARATUS, DIVERSITY RECEIVING METHOD, SEMICONDUCTOR INTEGRATED CIRCUIT, AND RECEIVER

(76) Inventor: Shigeru Soga, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/743,942

(22) PCT Filed: Sep. 29, 2008
(86) PCT No.: PCT/JP2008/067635

§ 371 Date: Aug. 6, 2010

(30) Foreign Application Priority Data
Nov. 28, 2007 (JP) 2007-307802

(51) Int. Cl. H04L 27/00

(52) U.S. Cl. 375/316

(57) ABSTRACT

There is provided an apparatus, comprising: a first branch (2) and a second branch (3) each for demodulating frequency division multiplexing signals; and a branch judging unit (4), wherein: the first branch (2) includes a first judging unit (10) for judging a transmission mode of the frequency division multiplexing signals, thereby outputting a first mode judgment result and a first reliability value indicating reliability of the judgment; the second branch (3) includes a second judging unit (17) for judging a transmission mode of the frequency division multiplexing signals, thereby outputting a second reliability value indicating reliability of the judgment; and the branch judging unit (4) comprises: an outputting unit (21) for outputting identity information and branch comparison information; and a selecting unit (22) for selecting one of the first mode judgment result and the second mode judgment result based on the branch comparison information.

### TECHNICAL FIELD

The present invention relates to a diversity receiving apparatus, a diversity receiving method, a semiconductor integrated circuit, and a receiver that receive frequency division multiplexing signals, especially orthogonal frequency division multiplexing signals (hereinafter “OFDM” signals) used for digital terrestrial television services.

### BACKGROUND ART

In Japan, the digital terrestrial television services have been started since 2003 according to the ISDB-T standard. At first in Europe, North America, South America, and the Asian countries, and then in all of the world, contents of analog broadcasting are digitized, and then the digital terrestrial television services have been starting. In many of these countries, technology according to the ISDB-T standard of Japan, or technology based thereon is used, and the OFDM signals composed by orthogonally multiplexing many carriers on a frequency axis are utilized.

Herein, in the OFDM signals according to the ISDB-T standard, an FFT sampling number used for time frequency conversion and a guard interval length included in OFDM symbols may take one of predetermined cases, which are called transmission modes. The combination of an FFT sampling number and a guard interval length is defined for every transmission mode. A sending side can arbitrarily set up its transmission mode, and a receiving side cannot acquire information with respect to the transmission mode before having established the connection there-between. The transmission mode is arbitrarily set up by the sending side. Even if receiving the same TV program, when a receiving position exceeds the current broadcasting station unit (prefecture unit), the transmission mode may be changed to another transmission mode. When the broadcasting station changes while moving by a train or a car and watching, using a mobile terminal, the same program presented according to digital terrestrial television services, the transmission mode may be changed, and receiving the same program may become impossible caused thereby.

When decoding OFDM signals, this transmission mode, that is, the FFT sampling number and the guard interval length of the received OFDM signals must be judged.

A method using guard correlation is known as means for the judging the transmission mode. See Document 1 (Published Japanese patent Application Laid-open on No. 10-327122), Document 2 (Published Japanese patent Application Laid-open on No. 11-127131) and Document 3 (Published Japanese patent Application Laid-open on No. 2006-42297), for example.

The OFDM signals have a characteristic tough against multipaths. In order to obtain higher receiving precision, performing diversity receiving for every carrier multiplexed on a frequency axis has been proposed. See Document 4 (Published Japanese patent Application Laid-open on No. 2005-136471) and Document 5 (Published Japanese patent Application Laid-open on No. 2007-6264), for example.

A diversity receiving apparatus includes a plurality of branches, each of which composes/selects demodulated data of carriers, thereby improving demodulating precision.

[Document 1] Published Japanese patent Application Laid-open on No. H10-327122
[Document 2] Published Japanese patent Application Laid-open on No. H11-127131
[Document 3] Published Japanese patent Application Laid-open on No. 2006-42297
[Document 4] Published Japanese patent Application Laid-open on No. 2005-136471
[Document 5] Published Japanese patent Application Laid-open on No. 2007-6264

### DISCLOSURE OF INVENTION

### Problem(s) to be Solved by Invention

In the diversity receiving apparatus, antennas are artificially set up for every branch. Therefore, there may be a branch with a wrong receiving status caused by a status of the setting, or the like. Alternatively, the receiving status of a certain branch among the plurality of branches included in the diversity receiving apparatus may be deteriorated.

In the diversity receiving for every carrier, carriers demodulated by each branch are selected or composed. Therefore, when a carrier of a branch with a wrong receiving status is included, there is a problem that effect of the diversity receiving remarkably is reduced. In some cases, the demodulating precision may fall rather than a case where the diversity receiving is not performed.

In prior art, after having demodulated transmission control carriers (called TMCC carriers) and data carrier, the receiving status of each branch included in the diversity receiving apparatus is detected for the first time. For this reason, there is also a problem that a branch with a deteriorated receiving status cannot be known until a considerable time has passed after the start of receiving.

When demodulating the transmission control carriers and the data carriers, there is a problem that it is difficult to judge whether or not a receiving status of a branch is wrong, whether or not antennas have a problem, and whether or not composing/selecting in the diversity receiving has a problem.

The diversity receiving needs a plurality of branches. Therefore, transmission mode judging should be separately performed for each of the plurality of branches. In this case, when a judgment result indicates that transmission modes differ from each other, a problem that there is no principle indicating either of the transmission modes should be adopted for the demodulation may occur.

In view of the above, an object according to the present invention is to provide a diversity receiving apparatus, a diversity receiving method, a semiconductor integrated circuit, and a receiver that optimally select one of transmission mode judging results that may be different from one to another of the branches, and further that immediately detect a branch with a wrong receiving status after the start of receiving, thereby improving demodulating precision.

### Means for Solving Problem(s)

In order to resolve the above problem, a diversity receiving apparatus according to the present invention comprises: a first branch operable to demodulate frequency division multiplexing signals; a second branch operable to demodulate the frequency division multiplexing signals; and a branch judging unit, wherein: the first branch comprises a first judging unit operable to judge a transmission mode of the frequency division multiplexing signals, thereby outputting a first mode judgment result and a first reliability value indicating reliability of the first mode judgment result; the second branch comprises a second judging unit operable to judge a transmission mode of the frequency division multiplexing signals, thereby outputting a second reliability value indicating reliability of the second mode judgment result; and the branch judging unit comprises: an outputting unit operable to compare the first mode judgment result with the second mode judgment result to output a first comparison result as identity information, and to compare a receiving status of the first branch with a receiving status of the second branch based on the first reliability value and the second reliability value to output a second comparison result as branch comparison information; and a selecting unit operable to select one of the first mode judgment result and the second mode judgment result based on the branch comparison information, thereby outputting the selected mode judgment result to at least one of the first branch and the second branch.

### EFFECT OF INVENTION

According to the present invention, an optimal mode judging result based on the reliability when judging is selected even when results of transmission mode judgment are different from one to another of the plurality of branches.

Since receiving statuses are judged for every branch immediately after receiving OFDM signals, that is, when transmission mode judging a branch having a problem can be specified at an early stage. The result of this specifying enables to early remove the branch that may have a wrong influence upon demodulating precision of diversity receiving.

Since it is judged at the early stage that quality of antennas and/or quality of setting thereof are not good, a user can easily consider repair and/or exchange them. That is, the diversity receiving apparatus and the receiver each of which possess high usability can be realized.

### BRIEF DESCRIPTION OF DRAWINGS

FIG. 1 is a mimetic diagram of OFDM signals in Embodiment 1 according to the present invention;

FIG. 2 is a diagram illustrating a carrier state of the OFDM signals in Embodiment 1 according to the present invention;

FIG. 3 is a diagram illustrating a segment structure of the OFDM signals in Embodiment 1 according to the present invention;

FIG. 4 is a block diagram of a diversity receiving apparatus in Embodiment 1 according to the present invention;

FIG. 5 is an internal block diagram of an equalizer in Embodiment 1 according to the present invention;

FIG. 6 is a diagram illustrating maximum ratio composition in Embodiment 1 according to the present invention;

FIG. 7 is a diagram explaining transmission mode judging in Embodiment 1 according to the present invention;

FIG. 8 is a diagram explaining reliability value calculation in Embodiment 1 according to the present invention;

FIG. 9 is an internal block diagram of a branch judging unit in Embodiment 1 according to the present invention;

FIG. 10 is a diagram explaining criterion of judgment in a branch controlling unit in Embodiment 2 according to the present invention;

FIG. 11 is a block diagram of a diversity receiving apparatus in Embodiment 3 according to the present invention;

FIG. 12 is a block diagram of a device that executes a signal demodulating method in Embodiment 4 according to the present invention;

FIG. 13 is a flow chart explaining a diversity receiving method in Embodiment 5 according to the present invention;

FIG. 14 is a block diagram of a semiconductor integrated circuit in Embodiment 5 according to the present invention;

FIG. 15 is a block diagram of a receiver in Embodiment 7 according to the present invention;

FIG. 16 is a perspective view of a mobile phone in Embodiment 7 according to the present invention;

FIG. 17 is a block diagram of a diversity receiving apparatus in Embodiment 8 according to the present invention;

FIG. 18 is an illustration of a decision table used by a fault judging unit in Embodiment 8 according to the present invention uses;

FIG. 19 is a block diagram of a diversity receiving apparatus in Embodiment 8 according to the present invention; and

FIG. 20 is a mimetic diagram of a displaying unit in Embodiment 8 according to the present invention.

### DESCRIPTION OF SYMBOLS

1: Diversity Receiving Apparatus
2: First Branch
3: Second Branch
4: Branch Judging Unit
5: First Tuner
6: First Analog-to-digital Converter
7: First Detecting Unit
8: First Time Frequency Converting Unit
9: First Equalizer
10: First Judging Unit
11: Second Antenna
12: Second Tuner
13: Second Analog-to-digital Converter
14: Second Detecting Unit
15: Second Time Frequency Converting Unit
16: Second Equalizer
17: Second Judging Unit
18: Branch Controlling Unit
19: Composing/selecting Unit
20: Error Correcting Unit

### BEST MODE FOR CARRYING OUT THE INVENTION

A first aspect according to the present invention provides a diversity receiving apparatus, comprising: a first branch operable to demodulate frequency division multiplexing signals; a second branch operable to demodulate the frequency division multiplexing signals; and a branch judging unit, wherein: the first branch comprises a first judging unit operable to judge a transmission mode of the frequency division multiplexing signals, thereby outputting a first mode judgment result and a first reliability value indicating reliability of the first mode judgment result; the second branch comprises a second judging unit operable to judge a transmission mode of the frequency division multiplexing signals, thereby outputting a second reliability value indicating reliability of the second mode judgment result; and the branch judging unit comprises: an outputting unit operable to compare the first mode judgment result with the second mode judgment result to output a first comparison result as identity information, and to compare a receiving status of the first branch with a receiving status of the second branch based on the first reliability value and the second reliability value to output a second comparison result as branch comparison information; and a selecting unit operable to select one of the first mode judgment result and the second mode judgment result based on the branch comparison information, thereby outputting the selected mode judgment result to at least one of the first branch and the second branch.

This arrangement enables to judge a receiving status for every branch immediately after start of receiving. As a result, a branch that may have influence upon demodulating precision in diversity receiving can be specified at an early stage. Although transmission modes are different from one to another of the branches, a judgment result of a transmission mode with higher reliability among them is used.

A second aspect according to the present invention provides, in addition to the first aspect, the diversity receiving apparatus, wherein each of the first mode judgment result and the second mode judgment result includes FFT sampling number information of the frequency division multiplexing signals and guard interval length information of the frequency division multiplexing signals.

This arrangement enables to perform demodulation with higher reliability.

A third aspect according to the present invention provides, in addition to the first aspect, the diversity receiving apparatus further comprising a branch controlling unit operable to control at least one of the first branch and the second branch based on at least one of the identity information, the branch comparison information, the first reliability value, and the second reliability value.

This arrangement enables to take countermeasures, such as removing a branch with a wrong receiving status from diversity receiving, at an early stage. As a result, deterioration of demodulating precision in diversity receiving can be avoided.

A fourth aspect according to the present invention provides, in addition to the third aspect, the diversity receiving apparatus wherein the branch controlling unit, when at least one of the first reliability value and the second reliability value is not greater than a predetermined value, performs at least one of stopping operation of a branch corresponding to the reliability value not greater than the predetermined value; and resetting the branch corresponding to the reliability value not greater than the predetermined value.

This arrangement enables to take countermeasures, such as removing a branch with a wrong receiving status from diversity receiving, at an early stage. As a result, deterioration of demodulating precision in diversity receiving can be avoided.

A fifth aspect according to the present invention provides, in addition to the third aspect, the diversity receiving apparatus wherein the branch controlling unit, when a difference between the first reliability value and the second reliability value is not less than a predetermined value, performs at least one of: stopping operation of a branch corresponding to the less reliability value of the first reliability value and the second reliability value; and resetting the branch corresponding to the less reliability value of the first reliability value and the second reliability value.

This arrangement enables to avoid deterioration, which may occur when a remarkable difference from one to another of the receiving statuses, of demodulating precision in the diversity receiving.

A sixth aspect according to the present invention provides, in addition to any of the first to fifth aspects, the diversity receiving apparatus wherein the branch judging unit outputs at least one of the identity information and the branch comparison information to at least one of an interrupt generating circuit, a control processor, an external register, and an external memory unit.

This arrangement enables to easily recognize existence of a branch with a wrong receiving status.

A seventh aspect according to the present invention provides, in addition to the sixth aspect, the diversity receiving apparatus wherein the interrupt generating circuit generates an interrupt signal based on at least one of received identity information and the branch comparison information.

This arrangement enables to easily control a branch with a wrong receiving status.

An eighth aspect according to the present invention provides, in addition to the first aspect, the diversity receiving apparatus wherein at least one of the first judging unit and the second judging unit performs judgment operation for every predetermined cycle.

This arrangement enables to surely detect change of receiving statuses in the branches.

Another aspect according to the present invention provides, in addition to the first aspect, the diversity receiving apparatus further comprising a fault judging unit wherein: the fault judging unit cumulatively stores a first initial value and a second initial value, the first initial value being the first reliability value at timing of at least one of when the first branch starts receiving and when the first branch changes a receiving bandwidth, the second initial value being the second reliability value at timing of at least one of when the second branch starts receiving and when the second branch changes a receiving bandwidth; the fault judging unit compares the first initial value with a predetermined threshold value to output a first comparison result; the fault judging unit compares the second initial value with a predetermined threshold value to output a second comparison result; and the fault judging unit judges each fault of the first branch and the second branch based on each of the first comparison result and the second comparison result.

This arrangement enables to detect a branch that is out of order among the plurality of branches provided with the diversity receiving apparatus at an early stage. As a result, a user can be recommended to early repair and/or exchange the branch, thereby configuring a high diversity receiving apparatus with high usability.

A furthermore other aspect according to the present invention provides, in addition to the other aspect, the diversity receiving apparatus wherein: the fault judging unit outputs a fault judging result indicating whether or not each of the first branch and the second branch is judged as “fault” to the branch controlling unit; and the branch controlling unit performs at least one of stopping operation of a branch judged as “fault”; and resetting the branch judged as “fault”.

Since this arrangement enables to automatically remove a branch judged as fault, deterioration caused thereby of receiving precision in the diversity receiving apparatus can be avoided.

Hereinafter, referring to the accompanying drawings, preferred Embodiments of the present invention will now be explained.

In the following Embodiments, OFDM signals based on the ISDB-T standard are mainly explained. The following explanation is, however, as the same with respect to not only OFDM signals not based on the ISDB-T standard, but also frequency division multiplexing signals that carriers have been multiplexed on a frequency axis, or the like.

Control information (first control information, and second control information) described in this specification includes TMCC signals in the ISDB-T standard, for example.

Needless to say, the words of “first” and “second” in this specification are used merely for distinguishing similar elements from each other, neither add a specific limitation nor mean excluding to add a further similar element.

Although this specification assumes that a diversity receiving apparatus is provided with two branches, the apparatus, however, may be provided three or more branches. In a case where the three or more branches are provided, a branch judging unit and a branch controlling unit should control respective output from the three or more branches.

### Embodiment 1

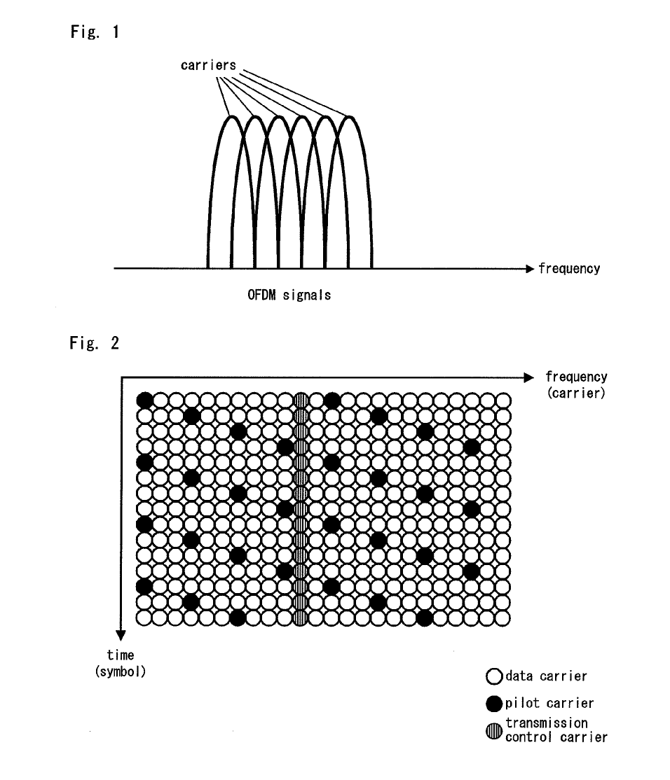

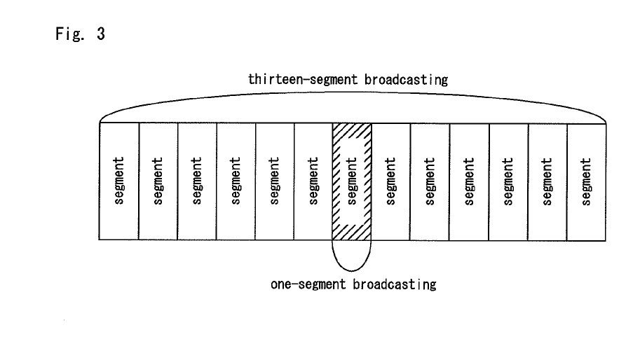

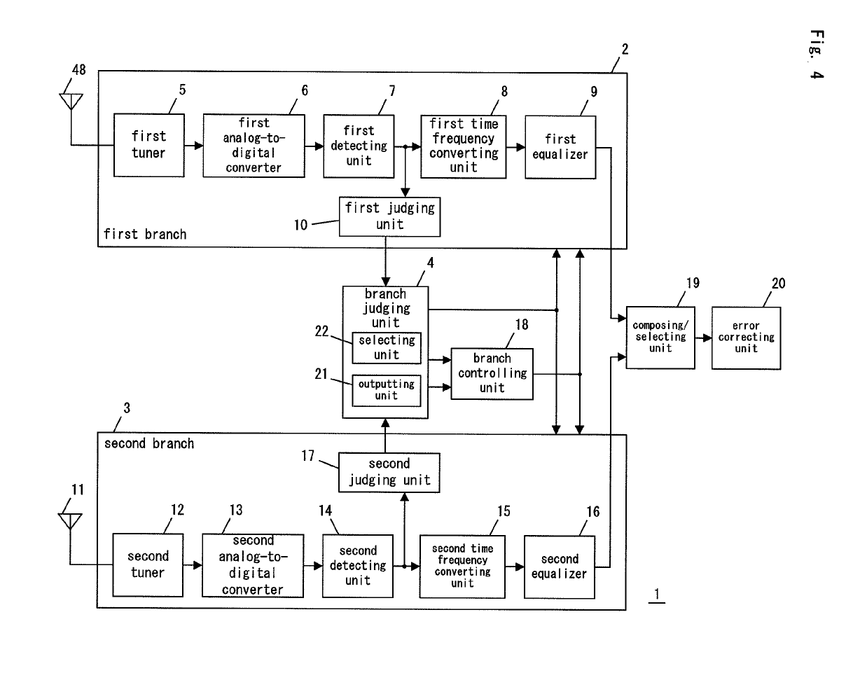

First, referring to FIG. 1, FIG. 2, and FIG. 3, the OFDM signals based on the ISDB-T standard will now be explained.

FIG. 1 is a mimetic diagram of the OFDM signals in Embodiment 1 according to the present invention. The OFDM signals are composed by multiplexing a plurality of carriers on a frequency axis. Especially, the carriers are mutually and orthogonally multiplexed. In general, it is thought that such OFDM signals are tough against multipaths.

FIG. 2 is a diagram illustrating a carrier state of the OFDM signals in Embodiment 1 according to the present invention. As shown in FIG. 2, in the OFDM signals, a plurality of carriers are multiplexed on the frequency axis to form one signal symbol (hereinafter a “symbol”), and a plurality of symbols are multiplexed on a time axis.

The OFDM signals include: data carriers including modulated visual and/or audio data; pilot carriers used for checking a status of a transmission path; and transmission control carriers for transmitting information with respect to transmission, such as a modulating method, a bandwidth, or the like.

As clear from FIG. 2, each transmission control carrier exists in the same position of each symbol. The pilot carriers are arranged at fixed interval. The data carriers are arranged in positions where the transmission control carriers and the pilot carriers do not exist.

FIG. 3 is a diagram illustrating a segment structure of the OFDM signals in Embodiment 1 according to the present invention.

As clear from FIG. 3, one OFDM signal bandwidth is divided into thirteen-segments in the ISDB-T standard. Broadcasting using carriers of all of the thirteen-segments is called thirteen-segment broadcasting, and broadcasting using only one central segment is called one-segment broadcasting. In many cases, the one-segment broadcasting is used for mobile terminals, such as a handheld device and a car-mounted terminal.

As clear from FIG. 3, in the one-segment broadcasting, since a used carrier number is less than that of thirteen-segment broadcasting, it easily becomes difficult to decode transmission control carriers and/or data carriers.

Next, the diversity receiving apparatus in Embodiment 1 will now be explained.

FIG. 4 is a block diagram of the diversity receiving apparatus in Embodiment 1 according to the present invention.

(General Outline)

First, a general outline will now be explained.

A diversity receiving apparatus 1 is provided with: a first branch 2; a second branch 3; and a branch judging unit 4. The first branch 2 and the second branch 3 demodulate the OFDM signals.

A first branch 2 is at least provided with: a first tuner 5; a first analog-to-digital converter 6; a first detecting unit 7; and a first judging unit 10, thereby judging a transmission mode of the OFDM signals received by the first branch 2.

The first tuner 5 receives a specific bandwidth of the receiving signals (including the OFDM signals) received by an antenna 48. The first analog-to-digital converter 6 converts analog signals outputted by the first tuner 5 into digital signals. The first detecting unit 7 orthogonally detects the digital signals. The first detecting unit 7 outputs a result of the detection to the first judging unit 10.

The first judging unit 10 judges a transmission mode of the OFDM signals, and outputs a first mode judgment result and a first reliability value indicating reliability of the judgment (namely, the first mode judgment result). The first judging unit 10 outputs the first mode judgment result and first reliability value to the branch judging unit 4.

Similarly, the second branch 3 is at least provided with: a second tuner 12; a second digital-to-analog conversion part 13; a second detecting unit 14; and a second judging unit 17, thereby judging a transmission mode of the OFDM signals received by the second branch.

The second tuner 12 receives a specific bandwidth of the receiving signals (including the OFDM signals) received by an antenna 11. The second analog-to-digital converter 13 converts analog signals outputted by the second tuner 12 into digital signals. The second detecting unit 14 orthogonally detects the digital signals. The second detecting unit 14 outputs a result of the detection to the second judging unit 17.

The second judging unit 17 judges a transmission mode of the OFDM signals, and outputs a second mode judgment result and a second reliability value indicating reliability of the judgment (namely, the second mode judgment result). The second judging unit 17 outputs the second mode judgment result and the second reliability value to the branch judging unit 4.

The branch judging unit 4 is further provided with: an outputting unit 21; and a selecting unit 22.

The outputting unit 21 compares the first mode judgment result with the second mode judgment result, judges whether these results agree/disagree, and outputs a result of this judgment as identity information. In addition, the outputting unit 21 compares a receiving status of the first branch with a receiving status of the second branch based on the first reliability value and the second reliability value, and outputs a comparing result as branch comparison information.

The selecting unit 22 selects either of the first mode judgment result and the second mode judgment result based on the first reliability value and the second reliability value. The selecting unit 23 outputs the selected mode judging result as a determined judgment result to the first branch 2 and the second branch 3. Based on the received determined mode judging result, the first branch 2 and the second branch 3 perform demodulation on the OFDM signals (for example, analog-to-digital conversion, or the like), respectively.

The first mode judgment result and the second mode judgment result include at least one of FFT sampling number information (an FFT size) and guard interval length information, respectively.

At this time, the receiving statuses of the first branch 2 and the second branch 3 are judged immediately after the antennas 4 and 11 receive the OFDM signals. In other words, the receiving statuses are judged before demodulation and equalization of carriers multiplexed according to FFT, or the like. The demodulation and the equalization of the carriers usually take a considerable processing time. That is, there is a merit that the receiving statuses of branches are judged at a very early stage after start of receiving the OFDM signals.

Thus, in the diversity receiving apparatus in Embodiment 1, since the receiving status for every branch is judged immediately after start of receiving, a branch that may contaminate demodulating precision can be judged at the early stage in diversity receiving. As a result, such a wrong branch can be removed from receiving process at the early stage.

If such early judgment cannot be performed, then the demodulating precision are not improved for a long time after the start of receiving, and the merit of diversity receiving may be remarkably spoiled. The diversity receiving apparatus according to the present invention can resolve such a problem.

When the transmission mode judging results of the first branch 2 and the second branch 3 differ from each other (when the first mode judgment result differs from the second mode judgment result), based on the first reliability value and the second reliability value, a mode judging result judged by a branch considered with higher reliability (the better judgment result) is selected as a determination mode judging result. As a result, demodulation of the OFDM signals based on the more suitable mode judging result can be performed.

Next, details of each element are explained.

(Antennas)

Antennas 4 and 11 receive propagation signals including the OFDM signals.

The antennas 4 and 11 may be equipped with an electronic device on which diversity receiving apparatus 1 has been mounted, or may be equipped with a car when the diversity receiving apparatus 1 is mounted on the car.

In many cases, the diversity receiving apparatus 1 is mounted on a mobile phone, a mobile terminal, a PDA, a notebook computer, a car navigation system, a car-mounted television set, a car-mounted terminal, or the like. In these cases, only the antennas may be installed afterward depending on application, or the antennas may be installed in a store. Alternatively, the antennas sold separately from the diversity receiving apparatus 1 may be used instead.

In such a situation, quality of antennas of a certain branch may be wrong caused by poor quality of the antennas or quality of installation thereof. Wrong receiving quality of a certain antenna causes deterioration of a receiving status of a branch with which the antenna is provided. In such a case, remarkable deterioration of demodulating precision of diversity cannot be avoided as it is.

Thus, quality of the antennas 4 and 11 and installation quality thereof greatly affect the demodulating precision in diversity receiving.

(First Tuner, Second Tuner)

The first tuner 5 and the second tuner 12 are included in different branches, respectively, and have, however, the same function and structure.

Based on a central frequency according to a broadcasting bandwidth, the first tuner 5 selects and receives a specific bandwidth of the OFDM signals received by the antenna 4.

The tuner 5 outputs the received OFDM signals as receiving signals to the first analog-to-digital converter 6.

Similarly, based on a central frequency according to a broadcasting bandwidth, the second tuner 12 selects and receives a specific bandwidth of the OFDM signals received by the antenna 11.

The second tuner 12 outputs the received OFDM signals as receiving signals to the second analog-to-digital converter 13.

When a difference from a frequency used by the first tuner 5 and the second tuner 12 to a frequency used by the first detecting unit 7 and the second detecting unit 14 exists, correction with respect to a frequency offset amount may be performed.

(First Analog-to-Digital Converter, Second Analog-to-Digital Converter)

The first analog-to-digital converter 6 and the second analog-to-digital converter 13 are included in different branches, respectively, and have, however, the same function and structure. Of course, differently configured parts may be used for the converters.

The first analog-to-digital converter 6 converts analog signals from the first tuner 5 into digital signals. The first analog-to-digital converter 6 possesses resolution according to the specification of the first branch 2.

The first analog-to-digital converter 6 outputs the converted digital signals to the first detecting unit 7.

Similarly, the second analog-to-digital converter 13 converts analog signals from the second tuner 12 into digital signals. The second analog-to-digital converter 13 possesses resolution according to the specification of the second branch 3.

The second analog-to-digital converter 13 outputs the converted digital signals to the second detecting unit 14.

(First Detecting Unit, Second Detecting Unit)

The first detecting unit 7 detects the digital signals outputted from the first analog-to-digital converter 6. The first detecting unit 7 outputs the detected signals to a first time frequency converting unit 8 and the first judging unit 10.

The first detecting unit 7 performs quadrature detection, and outputs complex base band signals.

Similarly, the second detecting unit 14 detects the digital signals outputted from the second analog-to-digital converter 13. The second detecting unit 14 outputs the detected signals to a second time frequency converting unit 15 and the second judging unit 17.

The second detecting unit 14 performs orthogonal detection, and outputs complex base band signals.

(First Time Frequency Converting Unit, Second Time Frequency Converting Unit)

The first time frequency converting unit 8 and the second time frequency converting unit 15 possesses the same function and structure. Of course, differently configured parts may be used for the units.

Herein, for simple explanation, the first time frequency converting unit 8 will now be representatively explained. The second time frequency converting unit is the same as the following explanation.

The first time frequency converting unit 8 converts output of the first detecting unit 7 from signals on a time axis to signals on a frequency axis. FFT may be used, for example. As long as possessing a function of converting a signal on a time axis to a signal on a frequency axis, conversion other than FFT may be used instead. For example, a first time frequency converting unit may use fractal, or other algorithm.

The first time frequency converting unit 8 converts the output of the first detecting unit 7 from signals on a time axis into signals on a frequency axis, thereby extracting data carriers, transmission control carriers, and pilot carriers that have been multiplexed on the frequency axis. When the signals are OFDM signals, each of the carriers has been orthogonally multiplexed.

The first time frequency converting unit 8 outputs the extracted data carrier or the like to a first equalizer 9.

The FFT equipped with the first time frequency converting unit 8 converts OFDM signals utilizing a FFT sampling number (that is, the size of the FFT) included in a determination mode judging result outputted from the branch judging unit 4.

FIG. 2 typically shows the OFDM signals extracted by this first time frequency converting unit 8.

The horizontal axis of FIG. 2 is a frequency axis, and the vertical axis of the same is a time axis. Each symbol of “O” given in FIG. 2 illustrates each carrier included in a carrier group. Each carrier has been multiplexed on the frequency axis. On the time axis, a plurality of these multiplexed carriers has been multiplexed as one symbol.

As clear from FIG. 2, there are included data carriers that image data and audio data have been modulated, pilot carriers, and transmission control carriers.

(First Equalizer, Second Equalizer)

The first equalizer 9 and the second equalizer 16 have the same structure and the same function. Of course, parts different from each other may be used for them.

Herein, for simple explanation, the first equalizer 9 will now be representatively explained. The second equalizer 16 is the same as the following explanation.

The first equalizer 9 performs amplitude phase control on data carriers and transmission control carriers based on pilot carriers. The first equalizer 9 calculates a reliability value indicating a receiving status. This reliability value is used by the composing/selecting unit 19 as a criterion of composing/selecting carriers so as to perform diversity receiving for every carrier.

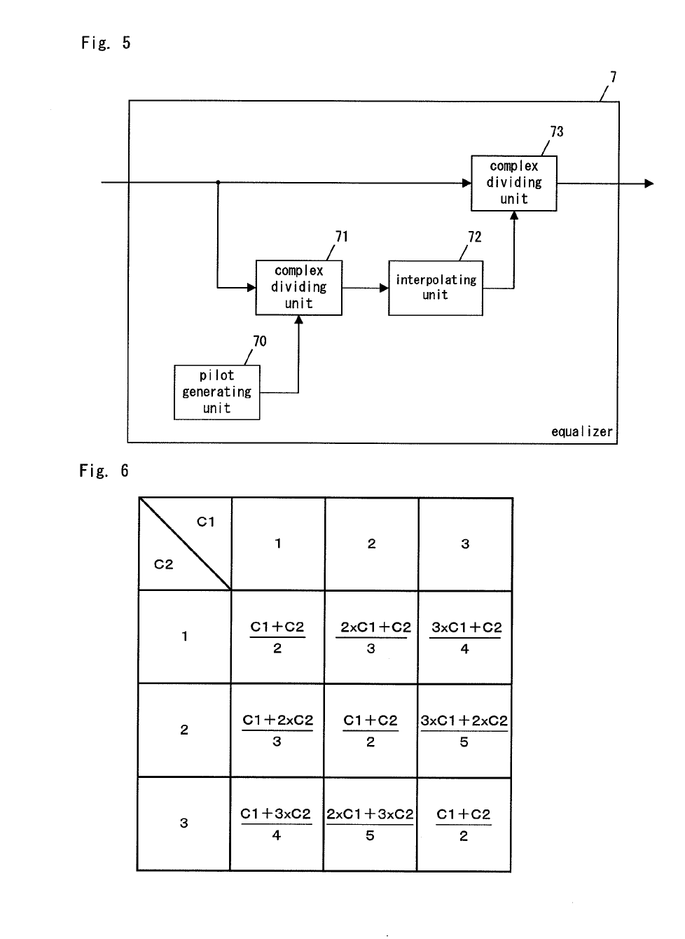

Referring to FIG. 5, the first equalizer 9 will now be explained. FIG. 5 is an internal block figure of the equalizer in Embodiment 1 according to the present invention.

The first equalizer 9 is provided with: a pilot generating unit 70; a complex dividing unit 71; an interpolating unit 72; and a complex dividing unit 73.

There is a pilot carrier whose phase and amplitude are known. The first equalizer 9 performs complex number division on received pilot carriers with the known pilot carrier, thereby calculating a fluctuation amount of the amplitude and the phase of the received pilot carriers. A transmission path status is presumed according to the calculated fluctuation amount.

The pilot generating unit 70 generates the pilot carrier whose amplitude and phase are known, and the complex dividing unit 71 performs complex number division on the received pilot carriers with this known pilot carrier.

The interpolating unit 72 superimposes results of the complex number division to output an average value thereof, thereby calculating optimal transmission path characteristics in receiving.

The complex dividing unit 73 performs complex number division on data carriers and transmission control carriers outputted from the first time frequency converting unit 8 according to the calculated transmission path characteristics, thereby equalizing these data carriers and transmission control carriers. Since the transmission path characteristics of the equalized data carriers and equalized transmission control carriers have been taken into consideration, demodulating precision thereof becomes higher.

The first equalizer 9 outputs the equalized data carriers and a reliability value thereof to the composing/selecting unit 19.

The first detecting unit 7 to the first equalizer 9 constitute the first demodulating unit that demodulates OFDM signals in the first branch 2, and the second detecting unit 14 to the second equalizer 16 constitute the second demodulating unit that demodulates to OFDM signals in the second branch 3.

(Composing/Selecting Unit)

The composing/selecting unit 19 is an element that performs diversity receiving for every carrier.

The composing/selecting unit 19 performs weighted composition (maximum ratio composition or the like.) on each data carrier outputted from the first equalizer 9 and the second equalizer 16 according to reliability values thereof, and selects either of data carriers outputted there-from according to the reliability values.

The maximum ratio composition means calculating an average value according to the reliability values, thereby composing a group of the first data carriers and another group of the second data carriers.

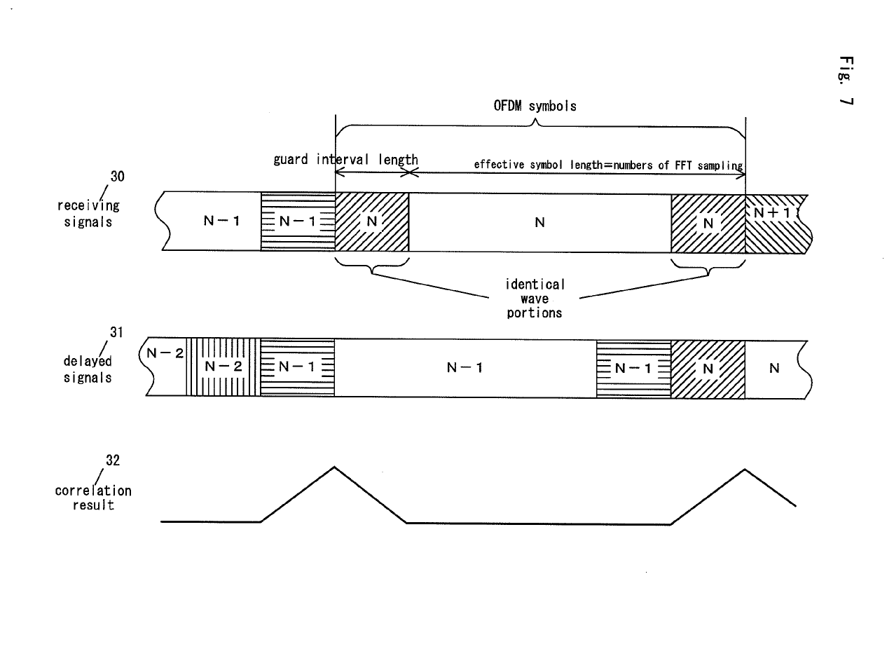

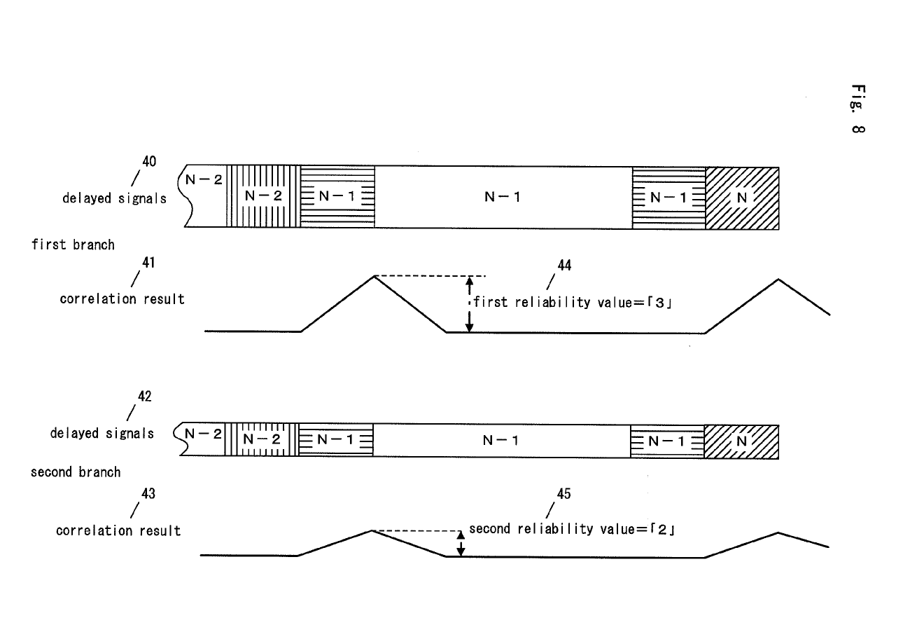

This will be explained referring to FIG. 6. FIG. 6 is a diagram illustrating the maximum ratio composition in Embodiment 1 according to the present invention.

In FIG. 6, the reliability values may have three steps of values from a value of “1” to a value of “3.” The greater the reliability value is, the higher reliability is had. That is, a reliability value of “3” means higher reliability than that of a reliability value of “1.” The label of “C1” means data carriers outputted from the first branch 2, and the label of “C2” means data carriers that are outputted from the second branch 3 and further that correspond to “C1” in a frequency position.

The top and horizontal row illustrates first reliability values of reliability values of the data carriers “C1”, and the left and vertical column illustrates second reliability values of reliability values of the carriers “C2.”

As shown in FIG. 6, the composing/selecting unit 19 performs maximum ratio composition based on the reliability values, and outputs results thereof. For example, when the first reliability value of the data carriers “C1” is a value of “2” and the second reliability value of the data carriers “C2” is a value of “1”, the composing/selecting unit 8 performs calculation according a formula of (2×C1+C2)/3 and outputs the result. The others are handled as shown in FIG. 6.

The composing/selecting unit 19 may composes, not using the maximum ratio composition, data carriers outputted from the first branch 2 and data carriers outputted from the second branch 3 with a fixed ratio.

The composing/selecting unit 19 performs composition/selection for every carrier.

The composition/selection for every carrier by the composing/selecting unit 19 enables to improve demodulating precision, and to reduce a bit error rate, thereby obtaining improved receiving performance.

The composing/selecting unit 19 outputs results thereof to an error correcting unit 20.

(Error Correcting Unit 20)

The error correcting unit 20 corrects errors of demodulated carriers and errors of digital data included in the carriers.

According to Viterbi decoding, Reed-Solomon decoding, or the like, the error correcting unit 20 detects and corrects errors of the data carriers and other data. The digital error corrected data are outputted as packet data with respect to visual and/or audio contents.

(First Judging Unit, Second Judging Unit)

The first judging unit 10 and the second judging unit 17 have the same structure and the same function. Of course, parts different from each other may be used for them.

Based on output from the first detecting unit 7, the first judging unit 10 judges a transmission mode, and outputs the judgment result as a first mode judgment result. The first mode judgment result includes information including items of a FFT sampling number and a guard interval length.

Herein, in the ISDB-T standard, three kinds of numbers of 2k, 4k, and 8k are defined as FFT sampling numbers, and four kinds of lengths of ¼, ⅛, 1/16, and 1/32 are defined as guard interval lengths with respect to the effective symbol length of OFDM symbols. That is, twelve kinds of combination of these items show transmission modes.

A part of the OFDM symbols constitute a guard interval, and the remainder constitutes an effective symbol length indicating a FFT sampling number. Accordingly, when a symbol period is detectable from the received OFDM signals, the guard interval length and the FFT sampling number can be also detected.

Referring to FIG. 7, transmission mode judging will now be explained.

FIG. 7 is a diagram explaining the transmission mode judging in Embodiment 1 according to the present invention. The transmission mode judging is not limited to a method shown in FIG. 7.

First, the first judging unit 10 delays received OFDM symbols for only an effective symbol length. In FIG. 7, receiving signals 30 are current OFDM signals received by the first judging unit 10, and delayed signals 31 are OFDM signals that the receiving signals 30 have been delayed for only the effective symbol length. The first judging unit 10 detects correlation between the receiving signals 30 and the delayed signals 31. This is because both of the receiving signals 30 and the delayed signals 31 are signals partially including the identical wave, a part of which is composed of a latter part of the effective symbol length and a part of the guard interval as shown with slanted lines in Figs. The receiving signals 30 and the delayed signal 31 correlate with each other at a portion of the identical wave.

The first judging unit 10 detects the correlation between the identical wave portions of the receiving signals 30 and the delayed signals 31, and calculates a correlation result 32. As clear from FIG. 7, calculating the correlation between the receiving signals 30 and the delayed signals 31 to perform moving integral calculation with respect to the effective symbol length on the result thereof causes to obtain the correlation result 32. For example, the correlation result 32, which is obtained by performing move integration on the received OFDM signals delayed for the corresponding effective symbol length, is of a triangular wave, peaks of which indicate an OFDM symbol period composed of the effective symbol length equal to the delay and the guard interval length equal to the moving integral range. Although not shown in Figs., performing delaying for an effective symbol length and move integration with respect to a guard interval length does not cause the peaks of the triangular wave indicating the OFDM symbol period to appear when at least one of the effective symbol length and the guard interval length does not correspond to the received OFDM signals.

As for delaying for the effective symbol length, the first judging unit 10 prepares three kinds of the numbers of FFT sampling (2k, 4k, and 8k) and four kinds of moving integral calculation with respect to the guard interval length, and performs the above calculation to obtain twelve kinds of guard correlation results of the OFDM symbols. A result in which the peaks of the triangular wave appear in a unit of a predetermined cycle of the OFDM symbols is detected from the twelve kinds of guard correlation results, and an FFT sampling number and a guard interval length of the received OFDM signal are judged.

Of course, this is a mere example, and other corresponding mode judging in accordance with the standard of the OFDM signals may be performed instead.

Thus, the first judging unit 10 calculates a first mode judgment result including information of the guard interval length and the FFT sampling number. The first judging unit 10 outputs the calculated first mode judgment result to the branch judging unit 4.

The second judging unit 17 also performs the same process as the first judging unit 10, and outputs a second mode judgment result to the branch judging unit 4.

The first judging unit 10 and the second judging unit 17 calculate reliability values in transmission mode judging thereof. The reliability values are indexes indicating how reliable the respective transmission mode judging is. In other words, the reliability values show reliability of the first mode judgment result itself.

Referring to FIG. 8, reliability values will now be explained.

FIG. 8 is a diagram explaining calculation of the reliability values in Embodiment 1 according to the present invention.

FIG. 8 shows how the first judging unit 10 calculates a first reliability value and how the second judging unit 17 calculates a second reliability value in parallel.

In FIG. 8, there are shown delayed signals 40 related to the first branch, which are OFDM signals delayed for only the effective symbol length as the same as explained with FIG. 7, and a correlation result 41. In addition, delayed signals 42 related to the second branch and a correlation result 43 are also shown.

The heights of triangular waves of the correlation result 41 and the correlation result 43 show peak values of correlation. The peak values are used for indexes indicating reliability of transmission mode judging. The higher the peak values are, the more the received signals and the delayed signals have identical wave portions. The more identity there is, the better the receiving status is.

Due to this, the reliability of transmission mode judging is calculated based on peak values in a correlation result.

In FIG. 8, the first mode judgment result of the transmission mode in the first branch 2 indicates that the first reliability value is judged to be a value of “3.” On the other hand, the second mode judgment result of the transmission mode in the second branch 3 indicates that the second reliability value is judged to be a value of “2.” The greater the value is, the higher reliability is.

Thus, the first judging unit 10 and the second judging unit 17 calculate the first reliability value and the second reliability value that show reliability in transmission mode judging, respectively.

The first judging unit 10 and the second judging unit 17 output the calculated first reliability value and the calculated second reliability value to the branch judging unit 4 with the first mode judgment result and the second mode judgment result.

The functions and operation of the second judging unit 17 are the same as those of the first judging unit.

(Branch Judging Unit)

The branch judging unit 4 is provided with: an outputting unit 21 and; a selecting unit 22.

The outputting unit 21 judges whether the first mode judgment result and the second mode judgment result agree/disagree with each other, and outputs a judgment result thereof as identity information. Based on the first reliability value and the second reliability value, the outputting unit 21 compares a receiving status of the first branch 2 with a receiving status of the second branch 3, and outputs a comparison result thereof as branch comparison information.

The outputting unit 21 compares the first mode judgment result with the second mode judgment result. Each of the first mode judgment result and the second mode judgment result includes FFT sampling number information and guard interval information.

The outputting unit 21 compares one of these results with the other using a comparing circuit, for example. The outputting unit 21 outputs agreed information indicating that the first mode judgment result and the second mode judgment result agree with each other when the results are the same. On the contrary, the outputting unit 21 outputs disagreed information indicating that the first mode judgment result and the second mode judgment result disagree with each other when the results are not the same. When the FFT sampling number and the guard interval length judged at one of the branches are not the same as those judged at the other of the branches, it is judged that the results are not the same. If so, the diversity receiving apparatus should select and use either of the results judged at the branches.

The outputting unit 21 outputs branch comparison information of a result of comparing a receiving status in the first branch 2 with that in the second branch 3.

For example, when the first reliability value is greater than the second reliability value, the outputting unit 21 outputs branch comparison information including an index indicating that the receiving status of the first branch 2 is better than that of the second branch 3. Alternatively, the outputting unit 21 may output the difference between the receiving status in the first branch 2 and that in the second branch 3 as the branch comparison information.

The outputting unit 21 also outputs the first reliability value and the second reliability value.

The information outputted by the outputting unit 21 indicates whether or not transmission mode judging at the branches agrees with each other, whether or not a branch with a wrong receiving status exists, whether or not receiving statuses of the branches differ from each other, and so on. Since these items of information is outputted immediately after the start of receiving the OFDM signals, there is a merit that a receiving status for every branch can be judged immediately after the start.

The selecting unit 22 selects either of the first mode judgment result and the second mode judgment result. In the selection, the selecting unit 22 selects either of the first mode judgment result and the second mode judgment result based on the first reliability value and the second reliability value. For example, if the first reliability value is a value of “3” and the second reliability value is a value of “1”, then the selecting unit 22 selects the first mode judgment result.

The selecting unit 22 outputs the selected mode judging result to the first branch 2 and the second branch 3. This is because the selected mode judging result includes the FFT sampling number information and guard interval length information required for demodulating the OFDM signals, each of which is needed by both of the first branch 2 and the second branch 3.

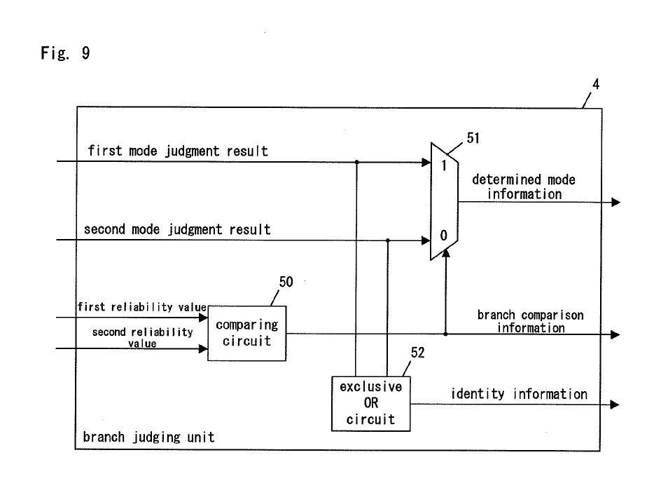

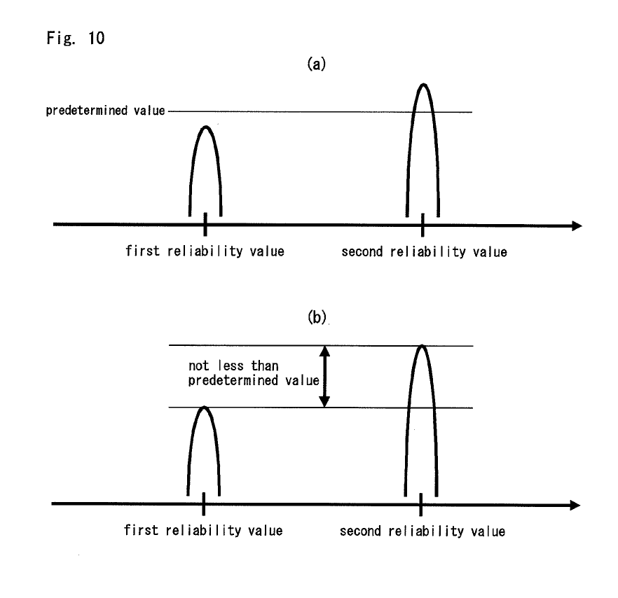

FIG. 9 shows an example of an internal structure of a branch judging unit 4. FIG. 9 is an internal block diagram of the branch judging unit in Embodiment 1 according to the present invention.

The branch judging unit 4 is provided with: a comparing circuit 50; a selector 51; and an exclusive OR circuit 52.

The comparing circuit 50 compares the first reliability value with the second reliability value. The comparing circuit 50 outputs a comparison result thereof as branch comparison information. The branch comparison information is used by the selector 51 that selects either of the first mode judgment result and the second mode judgment result.

The selector 51 selects either of the first mode judgment result and the second mode judgment result based on the branch comparison information. For example, when the branch comparison information shows that the receiving status of the first branch is good, the selector 51 selects the first mode judgment result.

The exclusive OR circuit 52 judges whether or not the first mode judgment result agrees with the second mode judgment result. Herein, each of the first mode judgment result and the second mode judgment result is expressed using a several bit signal, and the exclusive OR circuit 52 can easily judge the agreement/disagreement. The result of the exclusive OR circuit 52 is outputted as identity information.

Thus, the branch judging unit 4 not only selects a mode judging result by a branch with a reliable receiving status, but also can output an index indicating the receiving status of each branch. The index indicating the receiving status of each branch is very helpful when improving demodulating precision of the diversity receiving apparatus.

As mentioned above, the diversity receiving apparatus in Embodiment 1 can perform appropriately transmission mode judging even when there is a difference between receiving statuses of the branches, and can also judge the receiving statuses of the branches immediately after the start of receiving the OFDM signals.

### Embodiment 2

Next, Embodiment 2 will now be explained.

Embodiment 2 explains the function and structure for performing reception control for every branch in response to output from the branch judging unit 4.

FIG. 4 shows a branch controlling unit 18.

(Branch Controlling Unit)

Based on at least one of “the identity information”, the “branch comparison information,” the “first reliability value” and “the second reliability values” each of which is received from the branch judging unit 4, the branch controlling unit 18 controls operation of a branch with a wrong receiving status among the first branch 2 and the second branch 3.

The branch comparison information includes an index of reliability at the time of the transmission mode judging one of the branches. It is thought that this reliability directly shows whether or not the receiving status is good.

Patterns of control will now be explained as follows.

(Pattern 1)

The branch comparison information received by the branch controlling unit 18 includes the first reliability value and the second reliability value. Alternatively, the branch controlling unit 18 may directly receive and recognize the first reliability value and the second reliability value.

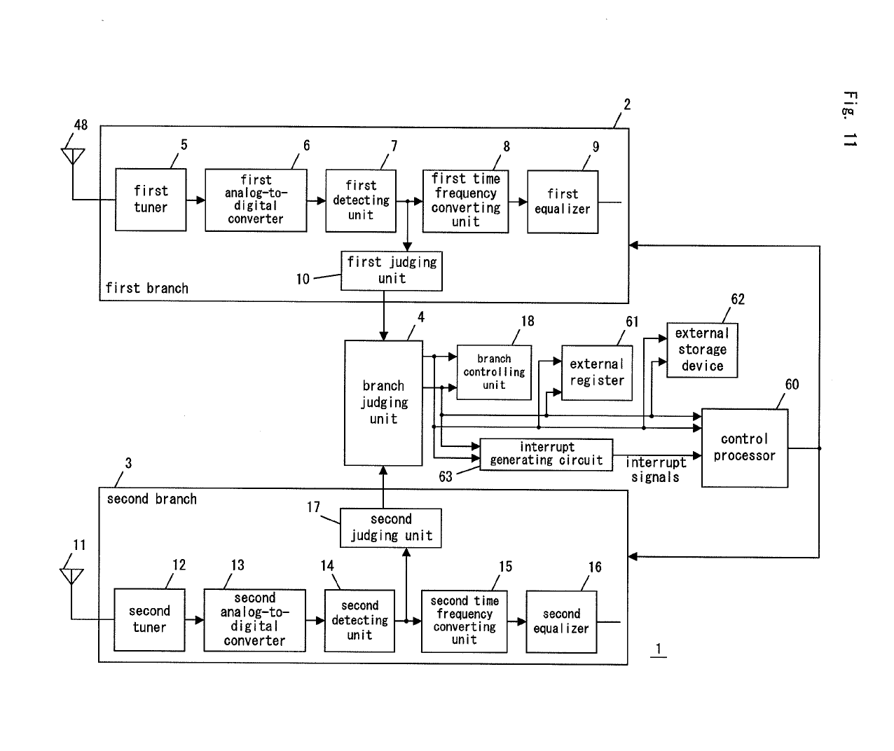

When at least one of the first reliability value and the second reliability value is not greater than a predetermined value, the branch controlling unit 18 controls a branch corresponding to the less reliability value. Explanation is made referring to FIG. 10. FIG. 10 is a diagram explaining a criterion of judgment in the branch controlling unit in Embodiment 2 according to the present invention.

FIG. 10 (a) shows a case of Pattern 1.

As shown in FIG. 10 (a), when the first reliability value is not greater than the predetermined value and the second reliability value is greater than the predetermined value, the branch controlling unit 18 judges that a receiving status of the first branch 2 is remarkably wrong. For this reason, the branch controlling unit 18 makes operation of the first branch 2 stop and/or reset. Of course, in other cases, the branch controlling unit 18 may make operation of the second branch 3 stop and/or reset.

(Pattern 2)

As shown in FIG. 10 (b), when the first reliability value and the second reliability value have a difference there-between not less than a predetermined value, the branch controlling unit 18 controls a branch corresponding to the small reliability value. A controlling method thereof is the same as that of Pattern 1.

For example, as shown in FIG. 10 (b), when the first reliability value is small and the difference between the first reliability value and the second reliability value is not less than the predetermined value, the branch controlling unit 18 makes operation of the first branch 2 stop and/or reset.

Control of the branches includes making operation of at least one of the branches stop and/or reset. The stopping is performed by stopping supply clocks to the one, or by stopping power supply thereto. The resetting can be performed by resetting a register included in the one, or by resetting software required for operation of the one.

The branch controlling unit 18 may directly compare the first reliability value with the second reliability value to perform judgment, or may check the first reliability value and the second reliability value according to the identity information (alternatively, the branch comparison information) only when the first branch 2 and the second branch 3 disagree.

In any of Pattern 1 and Pattern 2, the branch controlling unit 18 may control each branch using information indicated by the branch comparison information when the identity information indicates that there is disagreement.

The branch controlling unit 18 uses either of the items of information in accordance with design and/or specification thereof neither dependently nor limitedly.

Thus, since each receiving status of the branches is judged immediately after the start of receiving the OFDM signals; a branch with a wrong receiving status that may contaminate diversity receiving can be immediately removed. Stopping operation of a branch with a wrong receiving status causes the composing/selecting unit 19 not to use carriers demodulated by the branch with the wrong receiving status when performing composing/selecting for every carrier. As a result, deterioration of demodulating precision in diversity receiving caused by the branch with the wrong receiving status is avoided.

The receiving status for every branch is judged when judging a transmission mode immediately after detection. That is the receiving status for every branch is judged before demodulating carriers using FFT or the like. The judgment is performed at a very early stage, whether or not there is a problem concerning quality of antennas and/or setting thereof can be also easily presumed. For this reason, problems of an apparatus that the diversity receiving apparatus has been mounted thereon are judged at an early stage. There is a merit that repair thereof or the like can be early arranged.

### Embodiment 3

Next, Embodiment 3 will now be explained.

FIG. 11 is a block diagram of a diversity receiving apparatus in Embodiment 3 according to the present invention.

Explanation of elements attached with the same symbols as FIG. 4 is omitted.

The diversity receiving apparatus shown in FIG. 11 outputs information from the branch judging unit 4 to at least one of: an interrupt generating circuit 63; a control processor 60; an external register 61; and an external storage device 62.

The branch judging unit 4 outputs the identity information and the branch comparison information. Herein, the branch judging unit 4 outputs the information to at least one of: the interrupt generating circuit 63; the control processor 60; the external register 61; and the external storage device 62.

A user can easily monitor the receiving status for every branch because it is outputted to the control processor 60 and the external register 61. In response to the receiving status, a various kinds of processes can follow.

For example, the interrupt generating circuit 63 generates interrupt signals based on the received identity information and the received branch comparison information. The interrupt generating circuit 63 outputs the interrupt signals to the control processor 60. In response to these interrupt signals; the control processor 60 performs control such as stopping operation of the first branch 2 or the second branch 3 or the like.

By being stored by the external register 61 and the external storage device 62, the information can be monitored from the outside, or can be outputted to a display device provided with the outside.

Especially when a mobile phone or a mobile terminal performs diversity receiving therein, the receiving status for every branch can be displayed on a display device, thereby improving usability.

### Embodiment 4

Next, Embodiment 4 will now be explained.

The first judging unit 10 and the second judging unit 17 perform judgment after the start of receiving the OFDM signals. Once transmission mode judging has been established, the first judging unit 10 and the second judging unit 17 may continue to judge a transmission mode, or may end it. This is because the transmission mode is fundamentally the same as long as the same broadcast channel is used to watch the same program.

The corresponding broadcasting station is, however, is in a unit of a prefecture (local government) even when the same TV program is watched. OFDM signals from each broadcasting station placed per prefecture may have transmission modes differing from each other for every broadcasting station. For example, when watching a certain TV program with a mobile phone in Shinkansen, a transmission mode of the same TV program may be changed as the Shinkansen moves.

In such a case, it is preferable to always judge the transmission mode. Always judging the transmission mode, however, causes to increase power consumption thereby. In order to handle such problems, the first judging unit 10 and the second judging unit 17 may judge a transmission mode for every predetermined cycle. The first judging unit 10 and the second judging unit 17 judge a transmission mode for a defined cycle (every hour, or every ten minutes, for example).

Such a diversity receiving apparatus enables to surely judge the transmission mode that may be changed caused by the movements while avoiding to increase power consumption thereby.

### Embodiment 5

All or a part of functions of the diversity receiving apparatuses explained in Embodiment 1 to 4 may be implemented with software.

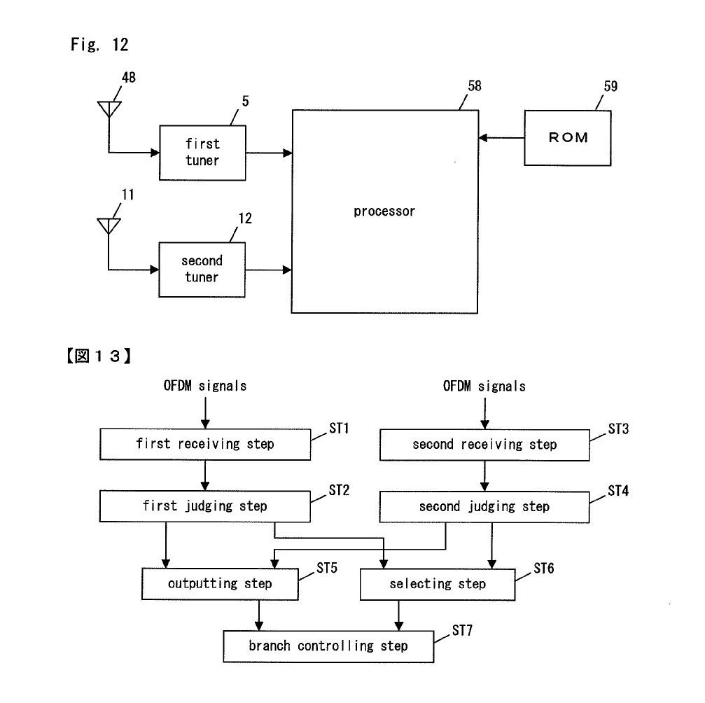

FIG. 12 is a block diagram of a device for executing the signal demodulating method in Embodiment 4 according to the present invention.

The antenna 2 receives propagation signals, and the tuner 3 receives a specific bandwidth thereof as receiving signals.

A processor 58 performs calculation process thereby realizing each function to be included in a signal demodulating device. Herein, the processor 58 performs signal demodulation according to a program stored on an ROM 59.

The processor 58 is composed of a CPU and/or a DSP. In FIG. 12, the first antenna 48, the first tuner 5, the second antenna 11, and the second tuner 12 are shown as elements of hardware. The first tuner 5 and the second tuner 12 may be, however, implemented with software.

The processor 58 reads the program stored on the ROM 59, and performs calculating according to procedures of the program, thereby performing signal demodulation.

Referring to FIG. 13, a diversity receiving method will now be explained. FIG. 13 is a flow chart explaining the diversity receiving method in Embodiment 5 according to the present invention.

First, at Step ST1, the processor 58 receives and detects OFDM signals. Next, at Step ST2, the processor 58 judges a transmission mode of the received OFDM signals, and calculates a first mode judgment result and a first reliability value.

In parallel to this, at Step ST3, the processor 58 receives and detects the OFDM signals. Next, at Step ST4, the processor 58 judges a transmission mode of the received OFDM signals, and calculates a second mode judgment result and a second reliability value.

Next, at Step ST5, the processor 58 judges whether or not the first mode judgment result and the second mode judgment result agree with each other, and outputs a judgment result as identity information. In addition, at Step ST5, based on the first reliability value and the second reliability value, the processor 58 compares a receiving status of the first branch with a receiving status of the second branch, and outputs a comparison result as branch comparison information.

At Step ST6, the processor 58 selects either of the first mode judgment result and the second mode judgment result. When selecting, the processor compares the first reliability value with the second reliability value as explained in any of Embodiments 1 to 4. The selected mode judging result is used in demodulating operation.

Next, at Step ST7, the processor 58 performs branch control. More concretely, based on at least one of the first reliability value, the second reliability value, the identity information, and the branch comparison information, a branch with a wrong receiving status is judged as explained in Embodiment 2. In FIG. 13, either of the first antenna 48 and the second antenna 11 may be judged instead. After the judgment, the processor 58 stops or resets demodulating operation corresponding to the branch with the wrong receiving status.

Thus, implementing a part or all of diversity receiving explained in any of Embodiments 1 to 4 with software enables to more easily realize the diversity receiving with functions and features according to the present invention.

### Embodiment 6

Next, Embodiment 6 will now be explained.

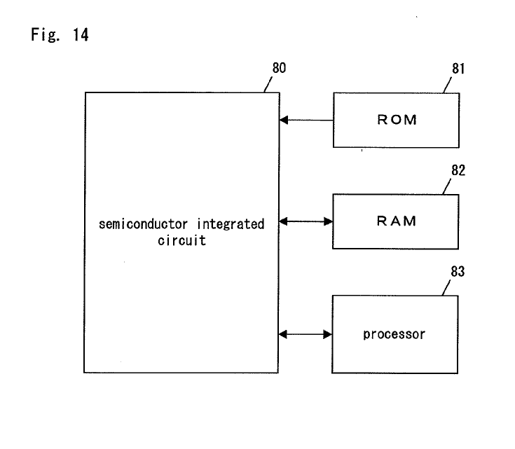

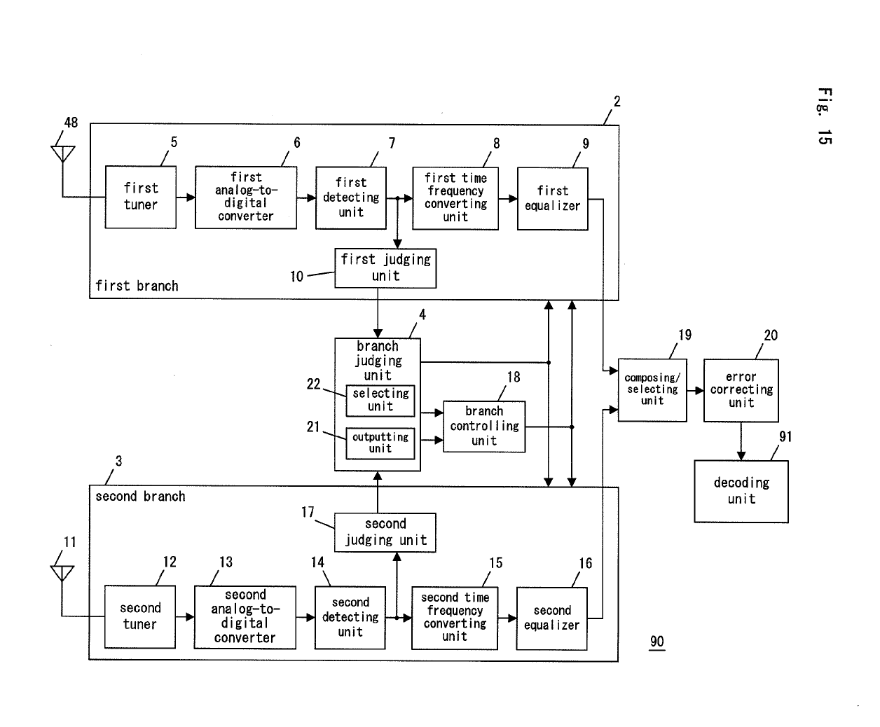

Embodiment 6 explains a case where all or a part of a signal demodulating device is realized with a semiconductor integrated circuit. FIG. 14 is a block diagram of the semiconductor integrated circuit in Embodiment 5 according to the present invention.

The semiconductor integrated circuit 80 is provided with elements explained in any of Embodiments 1 to 4. That is, the semiconductor integrated circuit 80 includes: a tuner function; a judging function; a branch judging function; a branch controlling function; an analog-to-digital converting function; a detecting function; a time frequency converting function; an equalizing function; an error correcting function; a first decoding function; a first correcting function; a first synchronization detecting function; a second decoding function; a second correcting function; a second synchronization detecting function; a control information arbitrating function; and a synchronous information arbitrating function. Each function is the same as those explained in any of Embodiments 1 to 4. Of course, all these functions do not have to be included and a part thereof may be included. These functions do not have to be integrated on a single semiconductor integrated circuit. In other words, they may be separately integrated on a plurality of semiconductor integrated circuits.

The semiconductor integrated circuit 80 possesses functions of two or more demodulation branches. The semiconductor integrated circuit 80 judges a transmission mode of received OFDM signals and then judgment results are calculated for every branch. A branch judging unit selects either of the modes judging results, a judge whether or not mode judging results agrees, and compares a receiving status of one of the branches with that of another of the branches.

In addition, based on the comparison of receiving statuses of the branches, control of making operation of a branch with a wrong receiving status stop and/or reset is performed. When such a wrong branch exists, demodulating precision of diversity receiving may be deteriorated.

As a result, the semiconductor integrated circuit 80 can remove a branch that may contaminate demodulating precision immediately after the start of receiving the OFDM signals. Furthermore, power consumption can also be reduced and the demodulating precision of diversity receiving can also be improved.

A part of function may be processed according to software that runs on a processor 83.

As shown in FIG. 14, the semiconductor integrated circuit 80 may be connected with an ROM 81, an RAM 82, and a processor 83 so as to perform necessary control and to utilize demodulation results there-between.

Since functions of diversity receiving are realized with the semiconductor integrated circuit, the size and power consumption of a device on which the semiconductor integrated circuit has been mounted can be reduced.

### Embodiment 7

Next, Embodiment 7 will now be explained.

In Embodiment 7, a receiver provided with the diversity receiving apparatus explained in any of Embodiments 1 to 4 is explained.

FIG. 15 is a block diagram of the receiver in Embodiment 7 according to the present invention. Explanation of elements attached with the same symbols as FIG. 4 is omitted.

A receiver 90 in FIG. 15 is configured by adding a decoding unit 91 to the diversity receiving apparatus 1 explained with FIG. 4.

The decoding unit 91 decodes packet data outputted from the error correcting unit 20, extracts audio and visual information included in the packet data, and converts them into a displayable state. Although not shown in FIG. 15, a display device, a speaker, or the like are preferably further provided so as to display images and to reproduce audio data.

The receiver 90 explained in Embodiment 7 also possesses the functions of the diversity receiving apparatus explained in any of Embodiments 1 to 4. Accordingly, a branch with a wrong receiving status can be judged immediately after the start of receiving the OFDM signals, and control of such a branch (that is, removing it from diversity receiving) is possible. When there are obtained mode judging results differing from one to another among a plurality of branches, a mode judging result with higher reliability can be adopted.

As a result, a receiver having improved demodulation performance in diversity receiving can be realized.

The receiver is preferably mounted on electronic devices, such as a mobile phone, a mobile terminal, a PDA, a car navigation system, a car-mounted television set, a car-mounted terminal, or the like. This is because these apparatuses perform reproduction based on television broadcasting or radio broadcasting in response to OFDM signals.

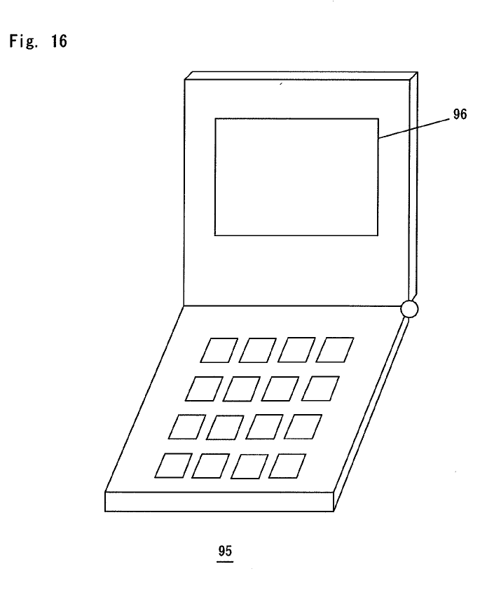

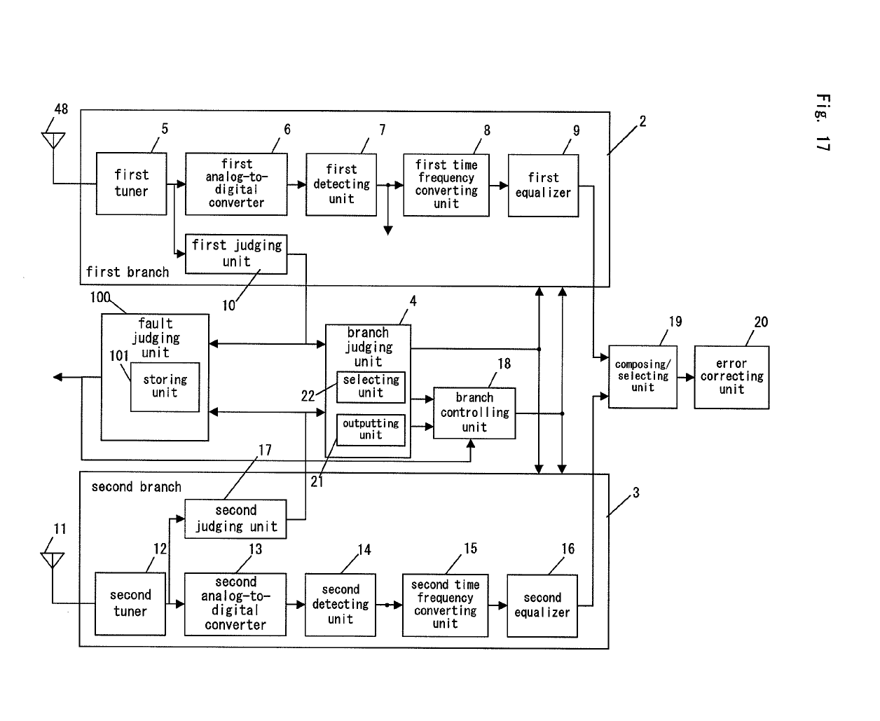

For example, as shown in FIG. 16, the receiver may be mounted on a mobile phone. FIG. 16 is a perspective view of the mobile phone in Embodiment 7 according to the present invention. A mobile phone 95 is provided with a displaying unit 96. The mobile phone 95 is also equipped with the receiver explained in FIG. 15.

The mobile phone 95 receives signals including OFDM signals. The mobile phone 95 performs signal demodulation explained in any of Embodiments 1 to 3. Finally, the mobile phone 95 displays images on the displaying unit 96, and makes a speaker sound.

A branch with a wrong receiving status judged by the branch judging unit 4 may be displayed on the displaying unit 96. Alternatively, the displaying unit may display thereon a branch whose operation is stopped by the branch controlling unit 18.

Such display causes to improve usability, thereby realizing a user-friendly receiver and/or a user-friendly electronic device.

The mobile phone 95 is a mere example of electronic devices on which the receiver may be preferably mounted. In addition to a non-portable television set, an Audio/Visual device, a computer, or the like, the receiver may be mounted on a moving terminal (a mobile terminal, a mobile phone, a car-mounted television set, a car navigation system, a portable television, a portable radio, and a notebook computer).

The signal demodulating device, the signal demodulating method, semiconductor integrated circuit, and the receiver according to the present invention can optimally demodulate not only OFDM signals based on the ISDB-T standard but also other frequency division multiplexing signals.

### Embodiment 8

Next, Embodiment 8 will now be explained.

In Embodiment 8, fault judging performed by a diversity receiving apparatus is explained. FIG. 17 is a block diagram of the diversity receiving apparatus in Embodiment 8 according to the present invention. A diversity receiving apparatus 1 is provided with: the first branch 2; and the second branch 3. The diversity receiving apparatus 1 may be, however, provided with three or more branches. Elements attached with the same symbols as FIG. 4 possess the same functions and structures as explained referring to FIG. 4. In FIG. 17, a fault judging unit 100 is an element newly added thereto.

The fault judging unit 100 is further provided with a storing unit 101.

The first judging unit 10 judges a transmission mode of OFDM signals, and outputs a first reliability value indicating reliability of a first mode judgment result and the judgment (that is, the first mode judgment result). When the first judging unit 10 can judge the transmission mode and can output the first reliability value at any time as long as the first branch 2 receives the OFDM signals. Herein, the first branch 2 starts the receiving when a power switch thereof is turned on, for example. Alternatively, the first branch 2 may start to receive a new receiving bandwidth when the receiving bandwidth is changed (receiving channel is changed).

The first reliability value when the first branch 2 receives signals indicates a receiving status of the first branch 2 as explained in any of Embodiments 1 to 7. For example, the less the first reliability value is, the more the receiving status is deteriorated. When the first reliability value changes from a first value to a second value less than the first value, it is shown that the receiving status changes from a good status to a wrong status. On the other hand, it is thought that the first reliability value obtained at the timing of at least one of when the first branch 2 starts the receiving and when the receiving bandwidth is changed may indicate not only the receiving status but also a fault of the first branch. When the first reliability value obtained at the timing of at least one of when the first branch 2 starts the receiving and when the receiving bandwidth is changed is small, a wrong receiving status may be indicated because the first branch 2 is out of order although the real receiving environment is good. When the first reliability value gets worse during the receiving, the wrong receiving status may be indicated because the first branch 2 suddenly becomes out of order although the real receiving environment is good. The fault when operating is, however, rare. On the other hand, in a non-used period, the first branch 2 may be out of order caused by impact, battery exhaustion, component damage, or the like, and then must start the receiving afterward at a fault.

Thus, a wrong first reliability value obtained at least one of when the receiving starts and when a receiving bandwidth is changed (when the receiving starts after the receiving bandwidth has been changed) may indicate that the first branch 2 is out of order. For this reason, the first reliability value obtained at least one of when the receiving starts and when the receiving bandwidth is changed (or when the first branch 2 starts the receiving instead) can be used as information indicating fault judging of the first branch 2.

This is the same as a second reliability value of the second branch 3. The second reliability value obtained at least one of when the receiving starts and when the receiving bandwidth is changed can be used as information indicating fault judging of the second branch 3. The fault judging unit 100 explained in Embodiment 8 judges whether or not the first branch 2 and the second branch 3 are out of order, respectively, using the first reliability value and the second reliability value in timing at least one of when the respective receiving starts and when the respective receiving bandwidth is changed. Herein, the first reliability value in timing at least one of when the respective receiving starts and when the respective receiving bandwidth is changed is defined as a first initial value, and the second reliability value in timing at least one of when the respective receiving starts and when the respective receiving bandwidth is changed is defined as a second initial value.

Only one initial value obtained in timing at least one of when the respective receiving starts and when the respective receiving bandwidth is changed may be not enough to use as fault judging information. For this reason, the fault judging unit 100 cumulatively stores the first initial value and the second initial value on the storing unit 101.

The storing unit 101 cumulatively stores the first initial value and the second initial value. And then, the fault judging unit 100 compares the first initial value with a predetermined threshold value to output a first comparison result, and compares the second initial value with the predetermined threshold value to output a second comparison result. The fault judging unit 100 judges whether or not the first branch 2 and the second branch 3 are out of order based on the first comparison result and the second comparison result, respectively. The fault judging unit 100 can output the judgment result.

Thus, the diversity receiving apparatus 1 in Embodiment 8 can judge whether or not the first branch 2 and the second branch 3 are out of order based on the first initial value which is one mode of the first reliability value from the first judging unit 10, and the second initial value which is another one mode of the second reliability value from the second judging unit 17.

(Judgment Method)

Next, an example of a method judging a fault by the fault judging unit 100 will now be explained.

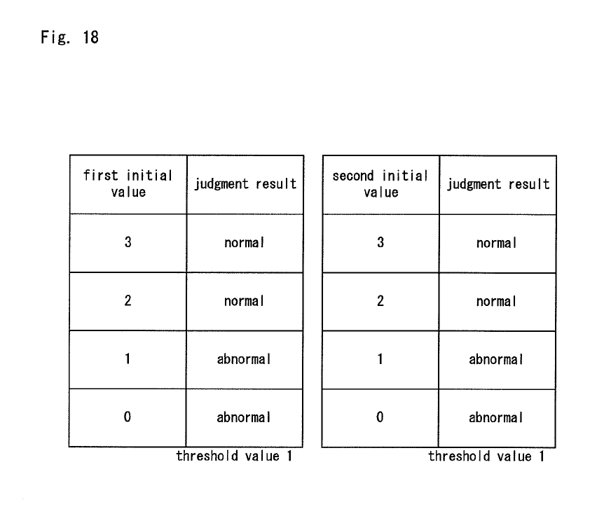

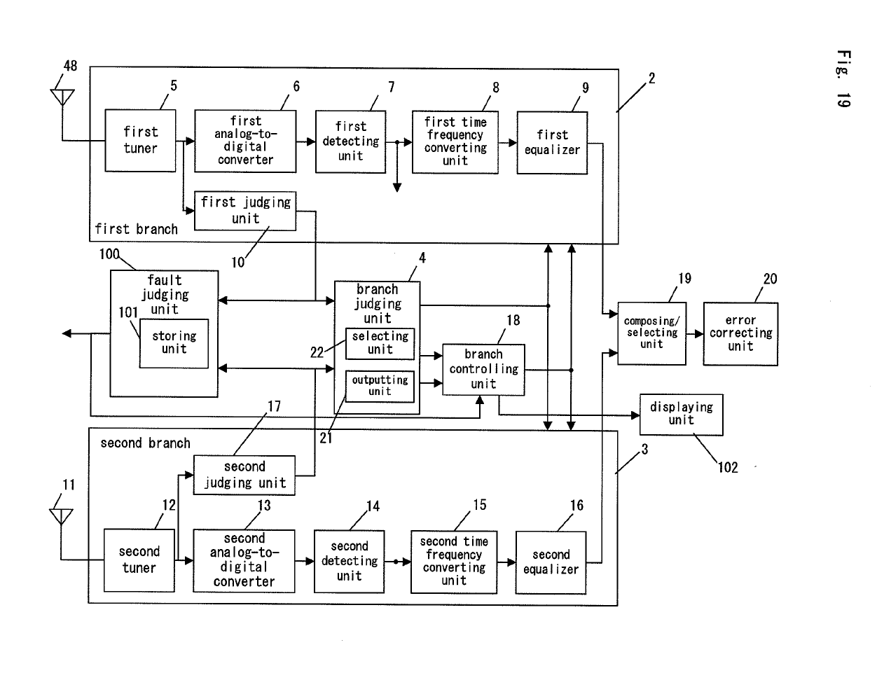

The fault judging unit 100 divides the first comparison result obtained by comparing the first initial value with the predetermined threshold value into either of a status of “normal” and a status of “abnormal”, and divides the second comparison result obtained by comparing the second initial value with the predetermined threshold value into either of a status of “normal” and a status of “abnormal”. For example, according to a decision table as shown in FIG. 18, the fault judging unit 100 divides the first comparison result and the second comparison result into either of a status of “normal” and a status of “abnormal”.

FIG. 18 illustrates the decision table used by the fault judging unit in Embodiment 8 according to the present.

The decision table of FIG. 18 shows a case where the first initial value includes a value of “0” to a value of “3” (the greater the value is, the higher reliability of receiving by the first branch 2 is) and further where the predetermined threshold value of the comparison target is a value of “1.” Similarly, the decision table also shows a case where the second initial value includes a value of “0” to a value of “3” (the greater the value is, the higher reliability of receiving by the second branch 3 is) and further where the predetermined threshold value of the comparison target is a value of “1.”

According to the decision table of FIG. 18, the fault judging unit 100 judges a status of “normal” when the first initial value is greater than a value of “1” of the predetermined threshold value, and otherwise judges a status of “abnormal.” Similarly, according to the decision table of FIG. 18, the fault judging unit 100 judges a status of “normal” when the second initial value is greater than a value of “1” of the predetermined threshold value, and otherwise judges a status of “abnormal.” That is, as shown in FIG. 18, the first comparison result is judged as a status of “abnormal” when the first initial value is a value of “0” or a value of “1”, and the first comparison result is judged as a status of “normal” when the first initial value is a value of “2” or a value of “3.” Similarly, the second comparison result is judged as a status of “abnormal” when the second initial value is a value of “0” or a value of “1”, and the second comparison result is judged as a status of “normal” when the second initial value is a value of “2” or a value of “3.”

The first comparison result and the second comparison result are obtained whenever the first initial value and the second initial value are obtained. The storing unit 101 cumulatively stores the first comparison result (judgment result included therein of a status of “normal” or a status of “abnormal”) and the second comparison result (judgment result included therein of the a status of “normal” and the a status of “abnormal”). When the fault judging unit 100 initializes the storing unit 101, the cumulatively stored first comparison result and second comparison result are erased, and then storing them newly restarts.

Next, the fault judging unit 100 judges that the first branch 2 is out of order when a number of times indicated to be a status of “abnormal” is more than a predetermined number in the cumulatively stored first comparison result. For example, the fault judging unit 100 judges that the first branch 2 is out of order when the storing unit 101 has stored the first comparison results for ten times and the first comparison results for ten times include six times judgment results of a status of “abnormal.”

Similarly, the fault judging unit 100 judges that the second branch 3 is out of order when a number of times indicated to be a status of “abnormal” is more than a predetermined number in the cumulatively stored second comparison result. For example, the fault judging unit 100 judges that the second branch 3 is out of order when the storing unit 101 has stored the second comparison results for ten times and the second comparison results for ten times include six times judgment results of a status of “abnormal.”

On the contrary, the fault judging unit 100 judges that the first branch 2 and the second branch 3 are not out of order, respectively, when a number of times indicated to be a status of “abnormal” is less than a predetermined number in each of the cumulatively stored first comparison result and the cumulatively stored second comparison result. The fault judging unit 100 judges the first branch 2 and the second branch 3, separately and respectively.

Thus, the fault judging unit 100 can judge whether or not the branches included in the diversity receiving apparatus 1 are out of order, respectively, based on the reliability value obtained in timing at least one of when the receiving starts and when the receiving bandwidth is changed.

(Control of Fault)

The fault judging unit 100 outputs a fault judging result indicating out of order to the branch controlling unit 18. For example, the fault judging unit 100 may output a judgment result indicating that the first branch 2 is out of order to the branch controlling unit 18.

In response to such a fault judging result, the branch controlling unit 18 performs at least one of: stopping operation of the branch judged to be out of order; and resetting the operation as explained in any of Embodiments 1 to 7. When a certain branch included in the diversity receiving apparatus 1 is out of order, performing diversity using carriers outputted from the out of order branch may cause to spoil receiving precision. For this reason, it is preferable for the branch judged to be out of order to stop and/or reset the branch, thereby avoiding contaminating the diversity receiving.

For example, when the fault judging unit 100 judges that the second branch 3 is out of order and outputs the fault judging result to the branch controlling unit 18, the branch controlling unit 18 makes the operation of the second branch 3 stop and/or reset.

Stopping the operation of the branch of operation is performed by stopping to supply clocks to the branch, and/or stopping power supply thereto. Making the branch reset can be performed by resetting a register included in the branch, and/or resetting software necessary for the operation of the branch.

Thus, the out of order branch can be removed from items of diversity receiving, thereby avoiding contaminating receiving precision of the diversity receiving. That is, stopping the operation of the branch with a wrong receiving status causes the composing/selecting unit 19 not to use carriers demodulated by the branch with the wrong receiving status when the composing/selecting unit 19 performs composing/selecting for every carrier. As a result, contaminating demodulating precision in the diversity receiving caused by the branch with the wrong receiving status is avoided.

(Displaying Fault)

The diversity receiving apparatus may further be provided with a displaying unit that displays information of a branch judged to be out of order, and information of a branch that the branch controlling unit has performed at least one of: stopping operation thereof; and resetting the operation.

FIG. 19 is a block diagram of the diversity receiving apparatus in Embodiment 8 according to the present invention. A displaying unit 102 is added to the diversity receiving apparatus 1 shown in FIG. 17.

The displaying unit 102 displays information of a branch judged to be out of order, and information of a branch that the branch controlling unit has performed at least one of: stopping operation thereof; and resetting the operation.

For example, when the fault judging unit 100 judges the first branch 2 to be out of order, the fault judging unit 100 outputs the fault judging result to the displaying unit 102 (directly, or indirectly). The displaying unit 102 may be an arbitrary device inspiring vision, a sense of hearing, or other feeling such as a liquid crystal display, an organic EL display, an LED display, a CRT, a display device composed of light-emitting devices, a speaker, a vibration generator, or the like. Based on the fault judging result received from the fault judging unit 100, the displaying unit 102 notifies a user that the first branch 2 is out of order by displaying the notification with letters, images, voices, and so on.

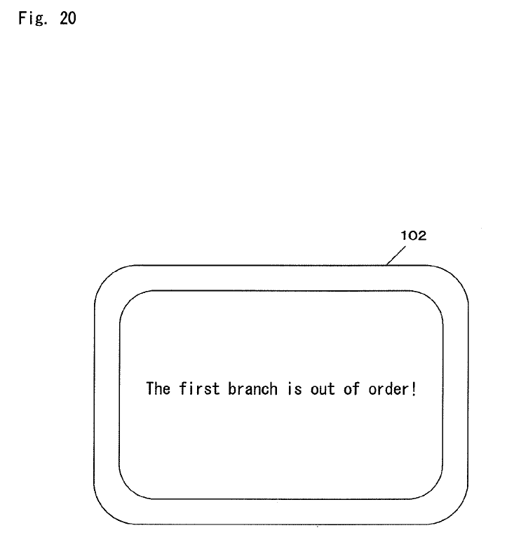

Alternatively, in response to notification from the fault judging unit 100, the displaying unit 102 may display the fact that the branch controlling unit 18 has performed at least one of: stopping operation of a branch; and resetting the branch. In this case, the branch controlling unit 18 outputs the result of having performed at least one of stopping operation of a branch; and resetting the branch to the displaying unit 102. In response to the output from the branch controlling unit 18, the displaying unit 102 notifies the user that the first branch 2 has stopped its operation by displaying the notification with letters, images, voices, and so on. When the displaying unit 102 is a display device, display is performed as shown in FIG. 20. FIG. 20 is a mimetic diagram of the displaying unit in Embodiment 8 according to the present invention. The displaying unit 102 displays the content of “The first branch is out of order.” on the display device with letters, for example. The user looks at this and can understand that the first branch is out of order.

Thus, in response to such display from the displaying unit 102, the user can be reminded of repairing the out of order branch and/or stopping the diversity receiving.

The displaying unit 102 may display fault information in various manners, and may also simultaneously display information other than faults.

The fault judging and the fault displaying explained in Embodiment 8 may be configured with not only hardware but also software. That is, the software includes, in addition to the steps explained in Embodiment 5, steps of: regarding a first reliability value in timing at least one of when the first branch 2 starts the receiving, and when a receiving bandwidth of the first branch 2 is changed as a first initial value; regarding a second reliability value in timing at least one of when the second branch 3 starts the receiving, and when a receiving bandwidth of the second branch 3 is changed as a second initial value; and cumulatively storing the first initial value and the second initial value. Furthermore, the software further includes fault judging steps of: comparing the first initial value with a predetermined threshold value to output a first comparison result; comparing the second initial value with the predetermined threshold value to output a second comparison result; and judging whether or not the first branch 2 and the second branch 3 are out of order, respectively, based on each of the first comparison result and the second comparison result. In addition, the software further includes: a step of controlling the branches in accordance with the results obtained by the fault judging; and a step of displaying information with respect to the fault judging.

As mentioned above, the fault judging the branches and the displaying fault information explained in Embodiment 8 may be configured with only hardware but also the software.

The fault judging the branches and the displaying fault information explained in Embodiment 8 may be implemented with a semiconductor integrated circuit.

The diversity receiving apparatus 1 explained in Embodiment 8 may be built in the receiver shown in FIG. 15 to constitute a part of the receiver. In short, the elements explained in any of Embodiments 1 to 8 may be combined with each other to realize a device, software, and a method.

The diversity receiving apparatus, the diversity receiving method, the semiconductor integrated circuit, and the receiver according to the present invention can perform demodulation of signals based on other standards concerning terrestrial broadcasting.

Herein, the first mode judgment result and the second mode judgment result in the ISDB-T standard include at least one of FFT sampling number information, guard interval length information, and symbol length information of frequency division multiplexing signals represented by OFDM signals. When based on one of the standards other than the ISDB-T standard, the first mode judgment result and the second mode judgment result include at least one of the modulation demodulation method information, communicating method information, and transmitting method information of the frequency division multiplexing signals (transmitted signals). In signal transmission based on the standards concerning terrestrial broadcasting, the transmitted signal include various kinds of mode information, and the signal demodulating device or the like can receive and demodulate the signals by analyzing this mode information.

The mode information includes at least one of the modulation demodulation method information, the communicating method information, and the transmitting method information. The first judging unit 10 and the second judging unit 17 analyze the mode information to output at least one of the modulation demodulation method information, the communicating method information, and the transmitting method information of the transmitted signals, each of which is included in the mode information, as the first mode judgment result and the second mode judgment result.

The modulation demodulation method information includes items of a method of such as QPSK, BPSK, 16QAM, and 64QAM. The communicating method information and the transmitting method information include values of a carrier wave frequency, a transmission bandwidth, or the like.

Thus, the signal demodulating device, the signal demodulating method, the semiconductor integrated circuit, and the receiving apparatus can judge at least one of the modulation demodulation method information, the communicating method information, and the transmitting method information as the first mode judgment result and the second mode judgment result, thereby enabling to handle transmitted signals based on various kinds of standards.

The diversity receiving apparatuses explained in any of Embodiments 1 to 8, the signal demodulating method, the semiconductor integrated circuit, and the receiver are related to mere examples according to the present invention. The present invention includes modification and/or reconstruction thereof within the scope of the present invention.

### INDUSTRIAL APPLICABILITY

The present invention can be preferably used, for example, in a field of a diversity receiving apparatus used for a handheld device or a mobile terminal that receives digital terrestrial television services, a field of a receiving apparatus field of the same, or the like.

1. A diversity receiving apparatus, comprising:
a first branch operable to demodulate frequency division multiplexing signals;
a second branch operable to demodulate the frequency division multiplexing signals; and
a branch judging unit, wherein:
said first branch comprises a first judging unit operable to judge a transmission mode of the frequency division multiplexing signals, thereby outputting a first mode judgment result and a first reliability value indicating reliability of the first mode judgment result;
said second branch comprises a second judging unit operable to judge a transmission mode of the frequency division multiplexing signals, thereby outputting a second reliability value indicating reliability of the second mode judgment result; and
said branch judging unit comprises:
an outputting unit operable to compare the first mode judgment result with the second mode judgment result to output a first comparison result as identity information, and to compare a receiving status of said first branch with a receiving status of said second branch based on the first reliability value and the second reliability value to output a second comparison result as branch comparison information; and
a selecting unit operable to select one of the first mode judgment result and the second mode judgment result based on the branch comparison information, thereby outputting the selected mode judgment result to at least one of said first branch and said second branch.

2. The diversity receiving apparatus as defined in claim 1, wherein
each of the first mode judgment result and the second mode judgment result includes FFT sampling number information of the frequency division multiplexing signals and guard interval length information of the frequency division multiplexing signals.

3. The diversity receiving apparatus as defined in claim 1, further comprising
a branch controlling unit operable to control at least one of said first branch and said second branch based on at least one of the identity information, the branch comparison information, the first reliability value, and the second reliability value.

4. The diversity receiving apparatus as defined in claim 3, wherein
said branch controlling unit, when at least one of the first reliability value and the second reliability value is not greater than a predetermined value, performs at least one of:
stopping operation of a branch corresponding to the reliability value not greater than the predetermined value; and
resetting the branch corresponding to the reliability value not greater than the predetermined value.

5. The diversity receiving apparatus as defined in claim 3, wherein
said branch controlling unit, when a difference between the first reliability value and the second reliability value is not less than a predetermined value, performs at least one of:
stopping operation of a branch corresponding to the less reliability value of the first reliability value and the second reliability value; and
resetting the branch corresponding to the less reliability value of the first reliability value and the second reliability value.

6. The diversity receiving apparatus as defined in claim 1, wherein
said branch judging unit outputs at least one of the identity information and the branch comparison information to at least one of an interrupt generating circuit, a control processor, an external register, and an external memory unit.

7. The diversity receiving apparatus as defined in claim 6, wherein
said interrupt generating circuit generates an interrupt signal based on at least one of received identity information and the branch comparison information.

8. The diversity receiving apparatus as defined in claim 1, wherein
at least one of said first judging unit and said second judging unit performs judgment operation for every predetermined cycle.

9. The diversity receiving apparatus as defined in claim 1, wherein
said first branch further comprises:
a first tuner operable to receive a specific bandwidth of receiving signals including the frequency division multiplexing signals;
a first analog-to-digital converter operable to convert analog signals outputted from said first tuner into digital signals;
a first detecting unit operable to detect the digital signals outputted from said first analog-to-digital converter;
a first time frequency converting unit operable to convert output of said first detecting unit from signals on a time axis into signals on a frequency axis to output carriers;
a first equalizer operable to equalize the carriers according to a transmission path characteristic; and
a first error correcting unit operable to perform error correction on output of said first equalizer, and
wherein said second branch further comprises:
a second tuner operable to receive a specific bandwidth of receiving signals including the frequency division multiplexing signals;
a second analog-to-digital converter operable to convert analog signals outputted from said second tuner into digital signals;
a second detecting unit operable to detect the digital signals outputted from said second analog-to-digital converter;
a second time frequency converting unit operable to convert output of said second detecting unit from signals on a time axis into signals on a frequency axis to output carriers;
a second equalizer operable to equalize the carriers according to a transmission path characteristic; and
a second error correcting unit operable to perform error correction on output of said second equalizer.

10. The diversity receiving apparatus as defined in claim 1, wherein
the frequency division multiplexing signals are orthogonal frequency division multiplexing signals that a plurality of carriers multiplexed on a frequency axis has been mutually and orthogonally multiplexed.

11. The diversity receiving apparatus as defined in claim 1, wherein
each of the first mode judgment result and the second mode judgment result includes at least one of modulation demodulation method information, communicating method information, and transmitting method information of the frequency division multiplexing signals.

12. The diversity receiving apparatus as defined in claim 1, further comprising a fault judging unit wherein:
said fault judging unit cumulatively stores a first initial value and a second initial value, the first initial value being the first reliability value at timing of at least one of when said first branch starts receiving and when said first branch changes a receiving bandwidth, the second initial value being the second reliability value at timing of at least one of when said second branch starts receiving and when said second branch changes a receiving bandwidth;
said fault judging unit compares the first initial value with a predetermined threshold value to output a first comparison result;
said fault judging unit compares the second initial value with a predetermined threshold value to output a second comparison result; and
said fault judging unit judges each fault of said first branch and said second branch based on each of the first comparison result and the second comparison result.

13. The diversity receiving apparatus as defined in claim 12, wherein:
each of the first comparison result and the second comparison result indicates a status of “normal” when each of the first initial value and the second initial value is greater than a predetermined threshold value;
each of the first comparison result and the second comparison result indicates a status of “abnormal” when each of the first initial value and the second initial value is not greater than the predetermined threshold value;
said fault judging unit judges said first branch as “fault” when the cumulatively stored first comparison results indicate a status of “abnormal” times not less than a predetermined number; and
said fault judging unit judges said second branch as “fault” when the cumulatively stored second comparison results indicate a status of “abnormal” times not less than the predetermined number.

14. The diversity receiving apparatus as defined in claim 13, wherein:
said fault judging unit outputs a fault judging result indicating whether or not each of said first branch and said second branch is judged as “fault” to said branch controlling unit; and
said branch controlling unit performs at least one of:
stopping operation of a branch judged as “fault”; and
resetting the branch judged as “fault”.

15. The diversity receiving apparatus as defined in claim 3, further comprising
a displaying unit operable to display information of a branch that said branch controlling unit has performed at least one of stopping operation and resetting thereon.

16. A diversity receiving method in a diversity receiving apparatus including: a first branch operable to demodulate frequency division multiplexing signals; a second branch operable to demodulate the frequency division multiplexing signals; and a branch judging unit, the diversity receiving method comprising:
a first judging step that said first branch judges a transmission mode of the frequency division multiplexing signals, thereby outputting a first mode judgment result and a first reliability value indicating reliability of the first mode judgment result;
a second judging step that said second first branch judges a transmission mode of the frequency division multiplexing signals, thereby outputting a second reliability value indicating reliability of the second mode judgment result;
an outputting step that said branch judging unit compares the first mode judgment result with the second mode judgment result to output a first comparison result as identity information, and compares a receiving status of said first branch with a receiving status of said second branch based on the first reliability value and the second reliability value to output a second comparison result as branch comparison information; and
a selecting step that said branch judging unit selects one of the first mode judgment results and the second mode judgment result based on the branch comparison information, thereby outputting the selected mode judgment result to at least one of said first branch and said second branch.

17. The diversity receiving apparatus as defined in claim 11, wherein operation of at least one of said first branch and said second branch is controlled based on at least one of the identity information, the branch comparison information, the first reliability value, and the second reliability value.

18. The diversity receiving apparatus as defined in claim 11, wherein said branch judging unit outputs at least one of the identity information and the branch comparison information to at least one of an interrupt generating circuit, a control processor, an external register, and an external memory unit.

19. The diversity receiving apparatus as defined in claim 11, wherein at least one of said first judging unit and said second judging unit performs judgment operation for every predetermined cycle.

20. The diversity receiving method as defined in claim 16, further comprising a fault judging step including:
cumulatively storing a first initial value and a second initial value, the first initial value being the first reliability value at timing of at least one of when said first branch starts receiving and when said first branch changes a receiving bandwidth, the second initial value being the second reliability value at timing of at least one of when said second branch starts receiving and when said second branch changes a receiving bandwidth;
comparing the first initial value with a predetermined threshold value to output a first comparison result; comparing the second initial value with a predetermined threshold value to output a second comparison result; and
judging each fault of said first branch and said second branch based on each of the first comparison result and the second comparison result.

21. A semiconductor integrated circuit, comprising:
a first branch operable to demodulate frequency division multiplexing signals;
a second branch operable to demodulate the frequency division multiplexing signals; and
a branch judging unit, wherein:
said first branch comprises a first judging unit operable to judge a transmission mode of the frequency division multiplexing signals, thereby outputting a first mode judgment result and a first reliability value indicating reliability of the first mode judgment result;
said second branch comprises a second judging unit operable to judge a transmission mode of the frequency division multiplexing signals, thereby outputting a second reliability value indicating reliability of the second mode judgment result; and
said branch judging unit comprises:
an outputting unit operable to compare the first mode judgment result with the second mode judgment result to output a first comparison result as identity information, and to compare a receiving status of said first branch with a receiving status of said second branch based on the first reliability value and the second reliability value to output a second comparison result as branch comparison information; and
a selecting unit operable to select one of the first mode judgment result and the second mode judgment result based on the branch comparison information, thereby outputting the selected mode judgment result to at least one of said first branch and said second branch.

22. The semiconductor integrated circuit as defined in claim 21, further comprising a fault judging unit wherein:
said fault judging unit cumulatively stores a first initial value and a second initial value, the first initial value being the first reliability value at timing of at least one of when said first branch starts receiving and when said first branch changes a receiving bandwidth, the second initial value being the second reliability value at timing of at least one of when said second branch starts receiving and when said second branch changes a receiving bandwidth; said fault judging unit compares the first initial value with a predetermined threshold value to output a first comparison result;
said fault judging unit compares the second initial value with a predetermined threshold value to output a second comparison result; and said fault judging unit judges each fault of said first branch and said second branch based on each of the first comparison result and the second comparison result.

23. A receiver, comprising:
a first branch operable to demodulate frequency division multiplexing signals;
a second branch operable to demodulate the frequency division multiplexing signals;
a branch judging unit;
a decoding unit operable to decode at least one of visual data and audio data; and
a displaying unit operable to display output of said decoding unit, wherein:
said first branch comprises:
a first judging unit operable to judge a transmission mode of the frequency division multiplexing signals, thereby outputting a first mode judgment result and a first reliability value indicating reliability of the first mode judgment result; and
a first demodulating unit operable to demodulate the frequency division multiplexing signals to output first demodulated data;
said second branch comprises:
a second judging unit operable to judge a transmission mode of the frequency division multiplexing signals, thereby outputting a second reliability value indicating reliability of the second mode judgment result; and
a second demodulating unit operable to demodulate the frequency division multiplexing signals to output second demodulated data; and
said branch judging unit comprises:
an outputting unit operable to compare the first mode judgment result with the second mode judgment result to output a first comparison result as identity information, and to compare a receiving status of said first branch with a receiving status of said second branch based on the first reliability value and the second reliability value to output a second comparison result as branch comparison information; and
a selecting unit operable to select one of the first mode judgment result and the second mode judgment result based on the branch comparison information, thereby outputting the selected mode judgment result to at least one of said first branch and said second branch, and wherein said decoding unit decodes at least one of the visual data and the audio data based on the first demodulated data and the second demodulated data.

24. The receiver as defined in claim 23, wherein:
said branch judging unit outputs at least one of the identity information and the branch comparison information to said displaying unit; and
said displaying unit displays receiving statuses of said first branch and said second branch based on at least one of the identity information and the branch comparison information.

25. The receiver as defined in claim 23, further comprising a fault judging unit wherein:
said fault judging unit cumulatively stores a first initial value and a second initial value, the first initial value being the first reliability value at timing of at least one of when said first branch starts receiving and when said first branch changes a receiving bandwidth, the second initial value being the second reliability value at timing of at least one of when said second branch starts receiving and when said second branch changes a receiving bandwidth; said fault judging unit compares the first initial value with a predetermined threshold value to output a first comparison result;
said fault judging unit compares the second initial value with a predetermined threshold value to output a second comparison result; and
said fault judging unit judges each fault of said first branch and said second branch based on each of the first comparison result and the second comparison result.
